(19) United States
(12) Patent Application Publication
(10) Pub. No.: US 2025/0293840 A1
(43) Pub. Date: Sep. 18, 2025

(54) ORTHOGONAL COVER CODE SUPPORT FOR SMALL DATA TRANSMISSION

(71) Applicant: QUALCOMM Incorporated, San Diego, CA (US)

(72) Inventors: Syed Hashim Ali SHAH, San Diego, CA (US); Alberto RICO ALVARINO, San Diego, CA (US); Chiranjib SAHA, Lakeside, CA (US); Ayan SENGUPTA, San Diego, CA (US)

(21) Appl. No.: 18/603,066

(22) Filed: Mar. 12, 2024

(51) Int. Cl. H04L 5/00; H04W 72/232; H04W 72/51

(52) U.S. Cl. CPC H04L 5/0053; H04W 72/232; H04W 72/51

(57) ABSTRACT

Various aspects of the present disclosure generally relate to wireless communication. In some aspects, a user equipment (UE) may transmit an indication of a capability for supporting an orthogonal cover code (OCC) for small data transmission (SDT). The UE may receive an OCC configuration that indicates a multiplexing order and an OCC codeword for the multiplexing order, and an OCC indication that indicates how to monitor a downlink in association with supporting the OCC for SDT. Numerous other aspects are described.

### FIELD OF THE DISCLOSURE

Aspects of the present disclosure generally relate to wireless communication and specifically relate to techniques, apparatuses, and methods for orthogonal cover code support for small data transmission.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include transmitting an indication of a capability for supporting an orthogonal cover code (OCC) for a configured grant (CG) small data transmission (SDT) or a preconfigured uplink resource (PUR). The method may include receiving an OCC configuration that indicates a multiplexing order and an OCC codeword for the multiplexing order, and an OCC indication that indicates how to monitor a downlink in association with supporting the OCC for the CG-SDT or the PUR.

Some aspects described herein relate to a method of wireless communication performed by a UE. The method may include transmitting a preamble associated with OCC support for transmission of a random access (RA) SDT with a 4-step random access channel (RACH) procedure, an RA-SDT with a 2-step RACH procedure, or an early data transmission (EDT). The method may include receiving an OCC configuration that indicates a multiplexing order and an OCC codeword for the multiplexing order.

Some aspects described herein relate to a method of wireless communication performed by a network entity. The method may include receiving a preamble or a capability indication associated with OCC support for a CG-SDT, a PUR, an RA-SDT with a 4-step RACH procedure, an RA-SDT with a 2-step RACH procedure, or an EDT. The method may include transmit, based at least in part on the capability indication, an OCC configuration that indicates a multiplexing order and an OCC codeword for the multiplexing order.

Some aspects described herein relate to an apparatus for wireless communication at a UE. The apparatus may include one or more memories and one or more processors coupled to the one or more memories. The one or more processors may be individually or collectively configured to transmit an indication of a capability for supporting an OCC for a CG-SDT or a PUR. The one or more processors may be individually or collectively configured to receive an OCC configuration that indicates a multiplexing order and an OCC codeword for the multiplexing order, and an OCC indication that indicates how to monitor a downlink in association with supporting the OCC for the CG-SDT or the PUR.

Some aspects described herein relate to an apparatus for wireless communication at a UE. The apparatus may include one or more memories and one or more processors coupled to the one or more memories. The one or more processors may be individually or collectively configured to transmit a preamble associated with OCC support for transmission of an RA-SDT with a 4-step RACH procedure, an RA-SDT 2-step with a RACH procedure, or an EDT. The one or more processors may be individually or collectively configured to receive an OCC configuration that indicates a multiplexing order and an OCC codeword for the multiplexing order.

Some aspects described herein relate to an apparatus for wireless communication at a network entity. The apparatus may include one or more memories and one or more processors coupled to the one or more memories. The one or more processors may be individually or collectively configured to receive a preamble or a capability indication associated with OCC support for a CG-SDT, a PUR, an RA-SDT with a 4-step RACH procedure, an RA-SDT with a 2-step RACH procedure, or an EDT. The one or more processors may be individually or collectively configured to transmit, based at least in part on the capability indication, an OCC configuration that indicates a multiplexing order and an OCC codeword for the multiplexing order.

Some aspects described herein relate to a non-transitory computer-readable medium that stores a set of instructions for wireless communication by a UE. The set of instructions, when executed by one or more processors of the UE, may cause the UE to transmit an indication of a capability for supporting an OCC for a CG-SDT or a PUR. The set of instructions, when executed by one or more processors of the UE, may cause the UE to receive an OCC configuration that indicates a multiplexing order and an OCC codeword for the multiplexing order, and an OCC indication that indicates how to monitor a downlink in association with supporting the OCC for the CG-SDT or the PUR.

Some aspects described herein relate to a non-transitory computer-readable medium that stores a set of instructions for wireless communication by a UE. The set of instructions, when executed by one or more processors of the UE, may cause the UE to transmit a preamble associated with OCC support for transmission of an RA-SDT with a 4-step RACH procedure, an RA-SDT with a 2-step RACH procedure, or an EDT. The set of instructions, when executed by one or more processors of the UE, may cause the UE to receive an OCC configuration that indicates a multiplexing order and an OCC codeword for the multiplexing order.

Some aspects described herein relate to a non-transitory computer-readable medium that stores a set of instructions for wireless communication by a network entity. The set of instructions, when executed by one or more processors of the network entity, may cause the network entity to receive a preamble or a capability indication associated with OCC support for a CG-SDT, a PUR, an RA-SDT with a 4-step RACH procedure, an RA-SDT with a 2-step RACH procedure, or an EDT. The set of instructions, when executed by one or more processors of the network entity, may cause the network entity to transmit, based at least in part on the capability indication, an OCC configuration that indicates a multiplexing order and an OCC codeword for the multiplexing order.

Some aspects described herein relate to an apparatus for wireless communication. The apparatus may include means for transmitting an indication of a capability for supporting an OCC for a CG-SDT or a PUR. The apparatus may include means for receiving an OCC configuration that indicates a multiplexing order and an OCC codeword for the multiplexing order, and an OCC indication that indicates how to monitor a downlink in association with supporting the OCC for the CG-SDT or the PUR.

Some aspects described herein relate to an apparatus for wireless communication. The apparatus may include means for transmitting a preamble associated with OCC support for transmission of an RA-SDT with a 4-step RACH procedure, an RA-SDT with a 2-step RACH procedure, or an EDT. The apparatus may include means for receiving an OCC configuration that indicates a multiplexing order and an OCC codeword for the multiplexing order.

Some aspects described herein relate to an apparatus for wireless communication. The apparatus may include means for receiving a preamble or a capability indication associated with OCC support for a CG-SDT, a PUR, an RA-SDT with a 4-step RACH procedure, an RA-SDT with a 2-step RACH procedure, or an EDT. The apparatus may include means for transmitting, based at least in part on the capability indication, an OCC configuration that indicates a multiplexing order and an OCC codeword for the multiplexing order.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of small data transmission (SDT) types, in accordance with the present disclosure.

FIG. 5 is a diagram illustrating an example of configured grant (CG) SDT, in accordance with the present disclosure.

FIG. 6 is a diagram illustrating an example of a preconfigured uplink resource (PUR) procedure, in accordance with the present disclosure.

FIG. 7 is a diagram illustrating an example of a 2-step random access (RA) SDT procedure, in accordance with the present disclosure.

FIG. 8 is a diagram illustrating an example of a 4-step RA-SDT procedure, in accordance with the present disclosure.

FIG. 9 is a diagram illustrating an example of early data transmission, in accordance with the present disclosure.

FIG. 10 is a diagram illustrating an example of a frequency domain orthogonal cover code (OCC) multiplexing of two UEs, in accordance with the present disclosure.

FIG. 11 is a diagram illustrating an example associated with frequency domain OCC-based physical uplink shared channel multiplexing, in accordance with the present disclosure.

FIG. 12 is a diagram illustrating an example associated with an OCC configuration for SDT, in accordance with the present disclosure.

FIG. 13 is a diagram illustrating an example of using an OCC for CG-SDT, in accordance with the present disclosure.

FIG. 14 is a diagram illustrating an example of using an OCC for PUR, in accordance with the present disclosure.

FIG. 15 is a diagram illustrating an example of using an OCC for 2-step RA-SDT, in accordance with the present disclosure.

FIG. 16 is a diagram illustrating an example of using an OCC for 4-step RA-SDT, in accordance with the present disclosure.

FIG. 17 is a diagram illustrating an example of using an OCC for EDT, in accordance with the present disclosure.

FIG. 18 is a diagram illustrating an example process performed, for example, at a UE or an apparatus of a UE, in accordance with the present disclosure.

FIG. 19 is a diagram illustrating an example process performed, for example, at a UE or an apparatus of a UE, in accordance with the present disclosure.

FIG. 20 is a diagram illustrating an example process performed, for example, at a UE or an apparatus of a UE, in accordance with the present disclosure.

FIG. 21 is a diagram illustrating an example process performed, for example, at a UE or an apparatus of a UE, in accordance with the present disclosure.

FIG. 22 is a diagram illustrating an example process performed, for example, at a UE or an apparatus of a UE, in accordance with the present disclosure.

FIG. 23 is a diagram illustrating an example process performed, for example, at a network entity or an apparatus of a network entity, in accordance with the present disclosure.

FIG. 24 is a diagram of an example apparatus for wireless communication, in accordance with the present disclosure.

FIG. 25 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Small data transmission (SDT) is a procedure that allows a user equipment (UE) to transmit data and/or signaling while remaining in a New Radio (NR) radio resource control (RRC) inactive state (Long Term Evolution (LTE) idle state), without transitioning to an RRC connected state (establishing a connection). The UE is able to conserve power and signaling resources by using low latency, low overhead, and power-efficient SDTs while avoiding the additional signaling that is involved with entering a connected mode.

There are different types of SDT. For NR, SDT may include random access channel (RACH) SDT, or RA-SDT. RA-SDT may include 2-step RA-SDT and 4-step RA-SDT. SDT for NR may also include configured grant (CG) SDT. For LTE, SDT may include early data transmission (EDT) during random access (RA) (for 4-step RACH). SDT for LTE may also include a preconfigured uplink resource (PUR). CG-SDT for NR is comparable to PUR for LTE. 4-step RA-SDT for NR is comparable to EDT for LTE.

In some scenarios, multiple UEs may be transmitting SDT data. In some aspects, the SDT transmissions of multiple UEs may be multiplexed at a network entity (e.g., base station) so that SDT transmissions from multiple UEs may occupy the same frequency-time resources. However, this multiplexing may cause interference at the base station.

Various aspects relate generally to wireless communications. Some aspects more specifically relate to a UE applying an orthogonal cover code (OCC) to an SDT data transmission. The OCC may be used to multiplex the signal in the same time resources. The data transmissions from UEs may be cover coded across repetitions in an orthogonal manner using an OCC. The OCC may help mitigate interference at the base station. In this way, multiple access schemes may be used to multiplex transmissions from multiple UEs, which increases throughput or capacity.

In some aspects, an OCC may be used in different SDT transmission schemes for NR and LTE. For example, an OCC may be used for CG-SDT (NR), RA-SDT with 2 step RACH (NR), RA-SDT with 4 step RACH (NR), and/or PUR (LTE) or EDT (LTE).

Particular aspects of the subject matter described in this disclosure can be implemented to realize one or more of the following potential advantages. By applying an OCC to SDT, EDT, or PUR, the throughput of UEs may increase significantly. This will result in low latency, low overhead, power-efficient, and high-throughput communications.

In some aspects, the network entity may transmit an OCC configuration. The OCC configuration may enable the UE to transmit uplink data during transmission of the CG-SDT using an OCC. The OCC configuration may enable the UE to transmit uplink data during transmission of the PUR using an OCC. The OCC configuration may enable the UE to transmit uplink data during transmission of the RA-SDT using an OCC. The OCC configuration may enable the UE to transmit uplink data during transmission of the EDT using an OCC.

In some aspects, the network entity may also enable UEs with OCC capabilities to monitor a downlink in SDT differently than UEs without OCC capabilities. The CG-SDT resource configuration may include or may be transmitted in the RRC release message with an OCC indication, such as an OCC flag. The OCC flag may indicate how the UE is to monitor subsequent downlink transmissions. Because UEs that support the use of an OCC (OCC UEs) may monitor a downlink differently than UEs that do not support OCC (non-OCC UEs), there may be different options in which an OCC-supporting UE may monitor the downlink.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

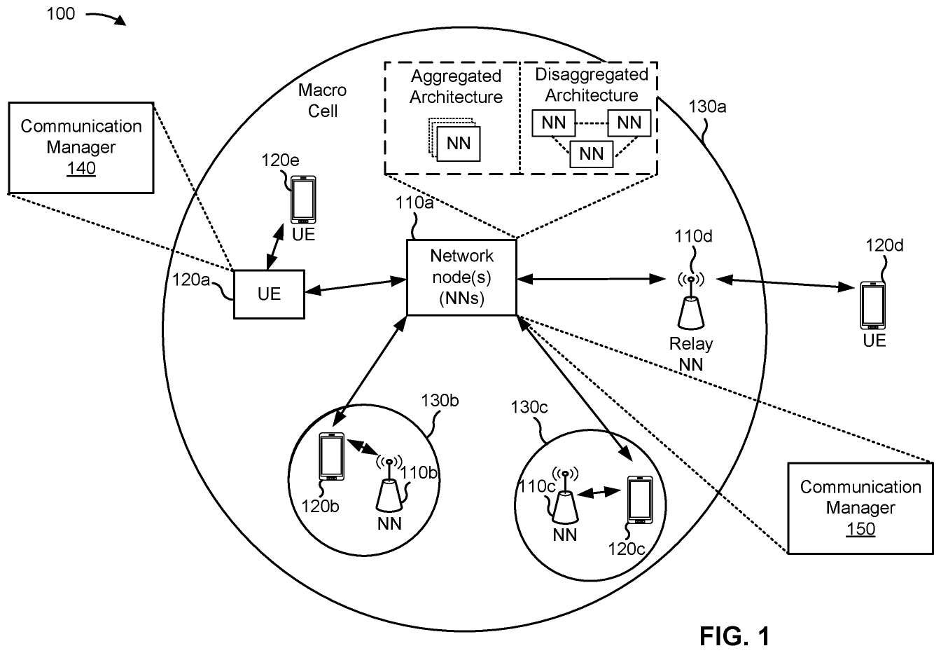

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (cMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., UE 120) may include a communication manager 140. As described in more detail elsewhere herein, the communication manager 140 may transmit an indication of a capability for supporting an orthogonal cover code (OCC) for a CG-SDT or a PUR. The communication manager 140 may receive an OCC configuration that indicates a multiplexing order and an OCC codeword for the multiplexing order, and an OCC indication that indicates how to monitor a downlink in association with supporting the OCC for the CG-SDT or the PUR. Additionally, or alternatively, the communication manager 140 may perform one or more other operations described herein.

In some aspects, a UE (e.g., a UE 120) may include a communication manager 140. As described in more detail elsewhere herein, the communication manager 140 may transmit a preamble associated with OCC support for transmission of an RA-SDT with a 4-step RACH procedure, an RA-SDT with a 2-step RACH procedure, or an EDT. The communication manager 140 may receive an OCC configuration that indicates a multiplexing order and an OCC codeword for the multiplexing order. Additionally, or alternatively, the communication manager 140 may perform one or more other operations described herein.

In some aspects, a network entity (e.g., a network node 110) may include a communication manager 150. As described in more detail elsewhere herein, the communication manager 150 may receive a preamble or a capability indication associated with OCC support for a CG-SDT, a PUR, an RA-SDT with a 4-step RACH procedure, an RA-SDT with a 2-step RACH procedure, or an EDT. The communication manager 150 may transmit, based at least in part on the capability indication, an OCC configuration that indicates a multiplexing order and an OCC codeword for the multiplexing order. Additionally, or alternatively, the communication manager 150 may perform one or more other operations described herein.

As indicated above, FIG. 1 is provided as an example. Other examples may differ from what is described with regard to FIG. 1.

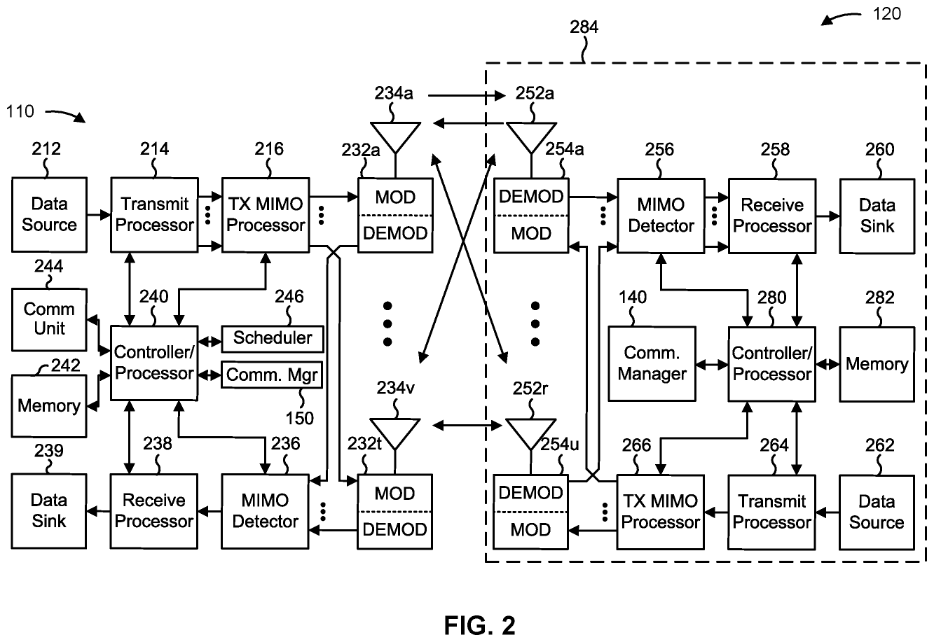

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

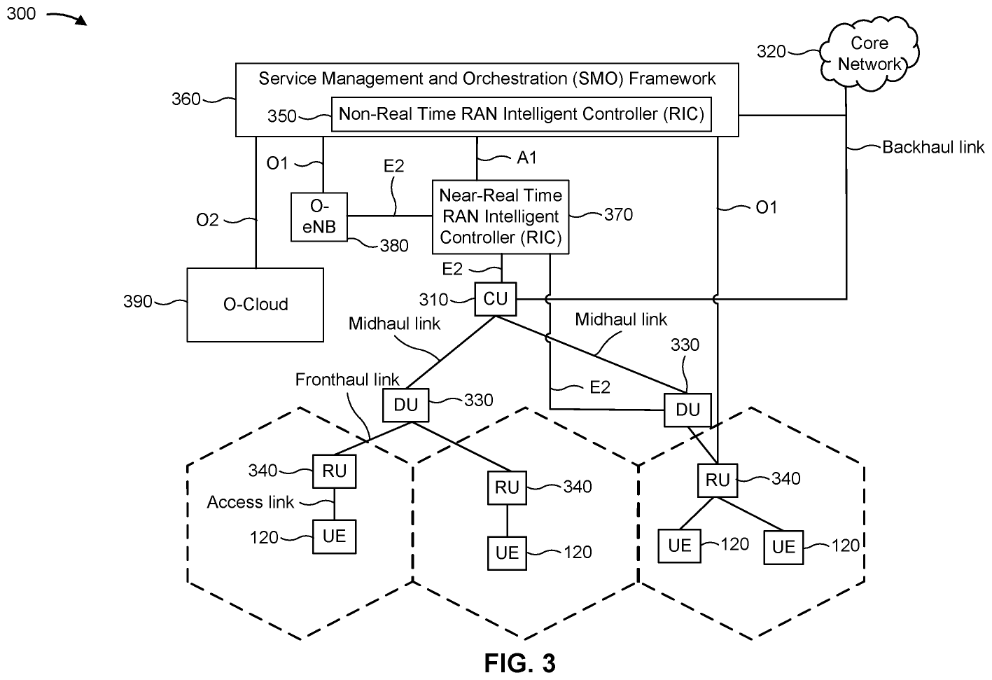

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-cNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

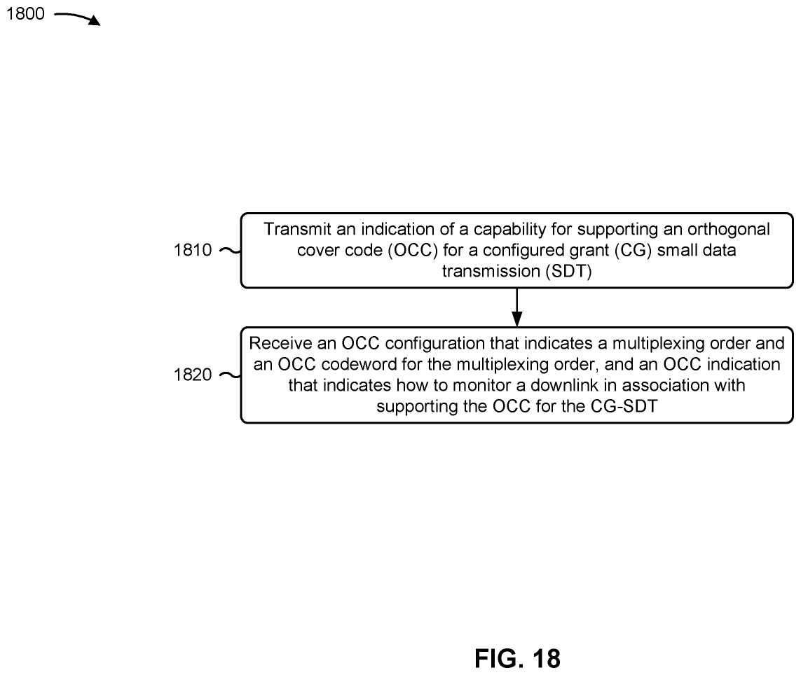

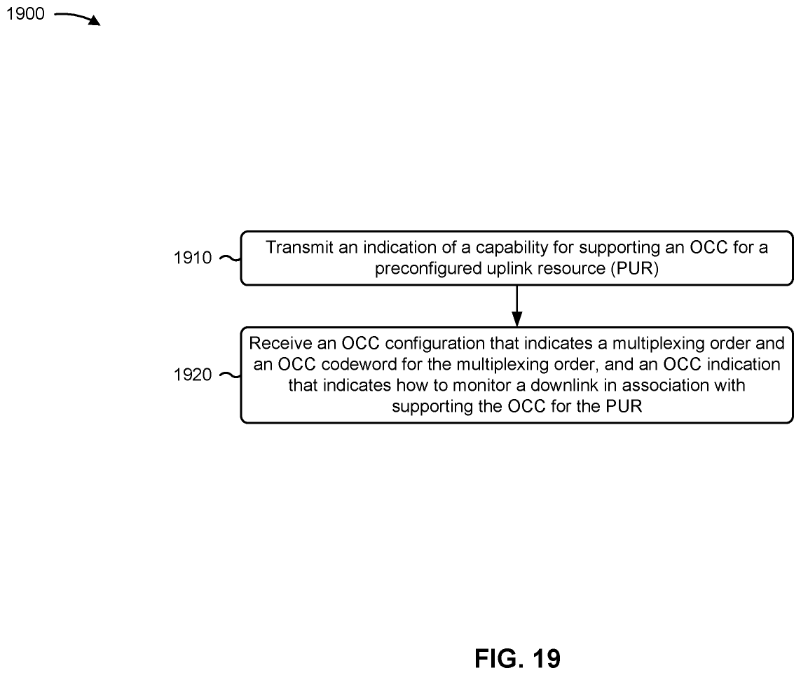

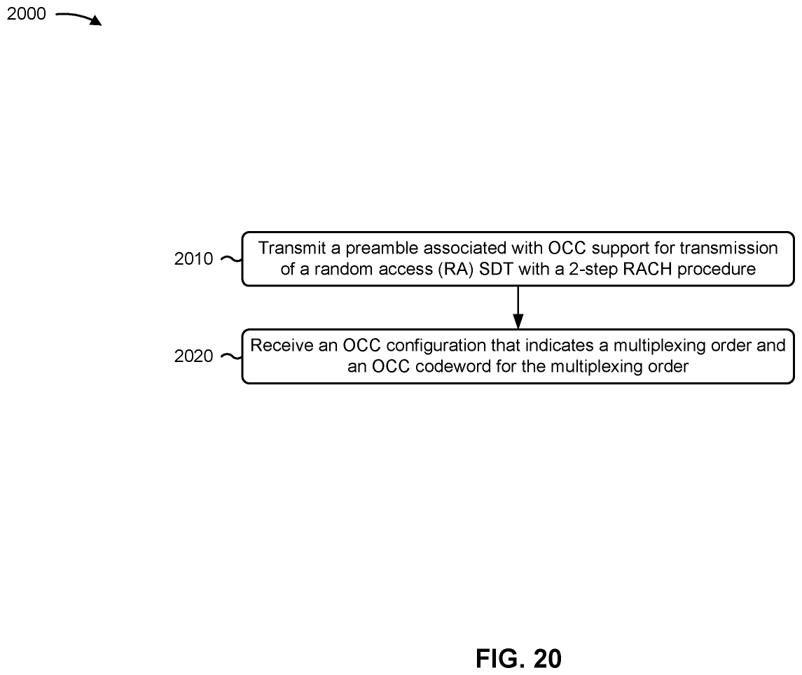

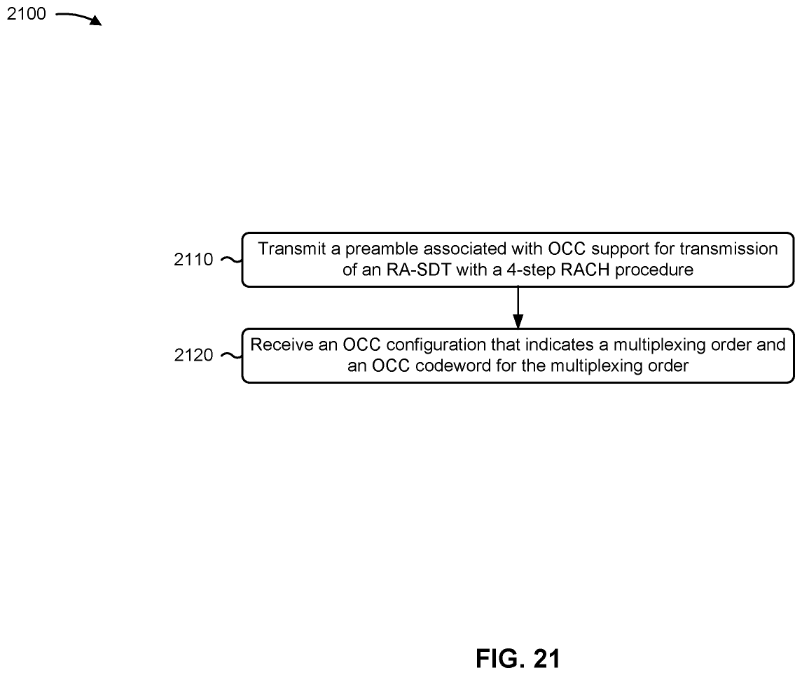

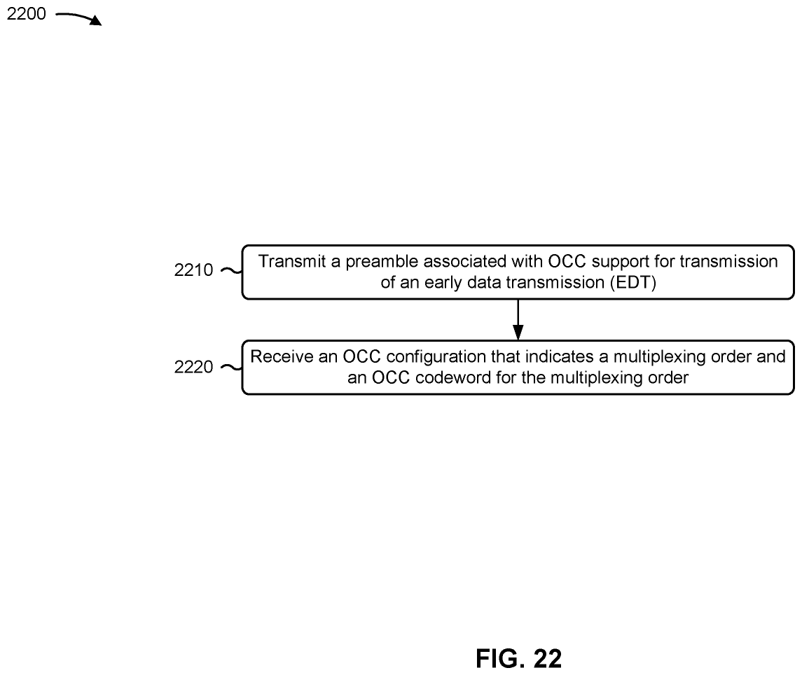

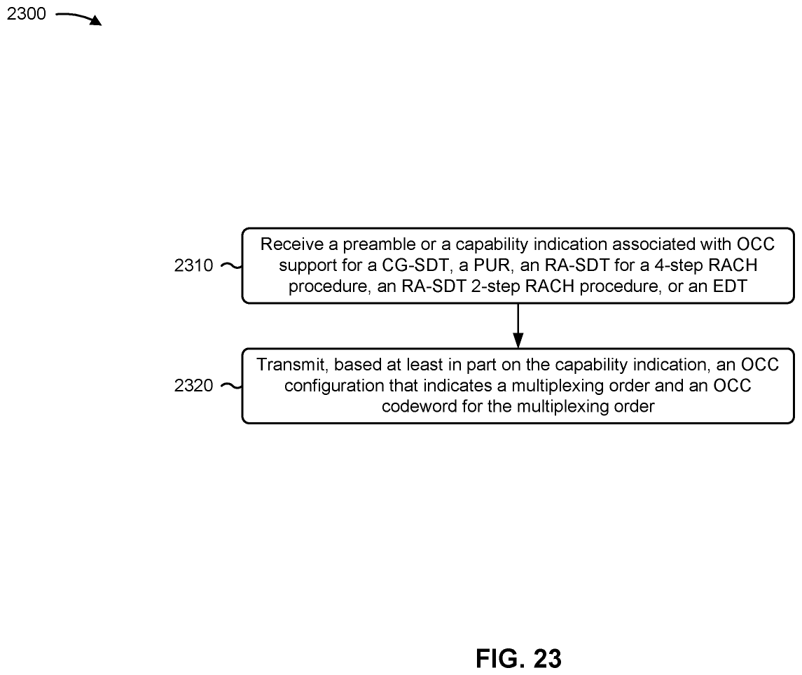

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with OCC for SDT, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1800 of FIG. 18, process 1900 of FIG. 19, process 2000 of FIG. 20, process 2100 of FIG. 21, process 2200 of FIG. 22, process 2300 of FIG. 23, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1800 of FIG. 18, process 1900 of FIG. 19, process 2000 of FIG. 20, process 2100 of FIG. 21, process 2200 of FIG. 22, process 2300 of FIG. 23, or other processes as described herein. In some examples, executing instructions may include running the instructions, converting the instructions, compiling the instructions, and/or interpreting the instructions, among other examples.

In some aspects, a UE (e.g., a UE 120) includes means for transmitting an indication of a capability for supporting an OCC for a CG-SDT or a PUR; and/or means for receiving an OCC configuration that indicates a multiplexing order and an OCC codeword for the multiplexing order, and an OCC indication that indicates how to monitor a downlink in association with supporting the OCC for the CG-SDT or the PUR. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a UE (e.g., a UE 120) includes means for transmitting a preamble associated with OCC support for transmission of an RA-SDT with a 4-step RACH procedure, an RA-SDT with a 2-step RACH procedure, or an EDT; and/or means for receiving an OCC configuration that indicates a multiplexing order and an OCC codeword for the multiplexing order. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a network node 110) includes means for receiving a preamble or a capability indication associated with OCC support for a CG-SDT, a PUR, an RA-SDT with a 4-step RACH procedure, an RA-SDT with a 2-step RACH procedure, or an EDT; and/or means for transmit, based at least in part on the capability indication, an OCC configuration that indicates a multiplexing order and an OCC codeword for the multiplexing order. In some aspects, the means for the network entity to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

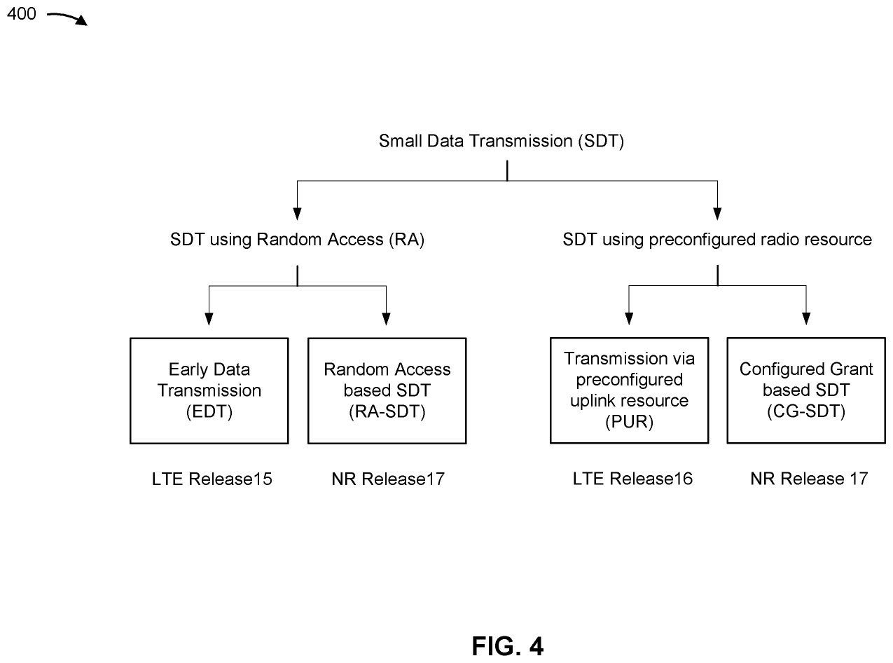

FIG. 4 is a diagram illustrating an example 400 of SDT types, in accordance with the present disclosure.

SDT is a procedure that allows a UE to transmit data and/or signaling while remaining in an NR RRC inactive state (LTE idle state), without transitioning to an RRC connected state (establishing a connection). The UE is able to conserve power and signaling resources by using low latency, low overhead, and power-efficient SDTs while avoiding the additional signaling that is involved with entering a connected mode.

There are different types of SDT. As shown by example 400, for NR, SDT may include RACH SDT, or RA-SDT. RA-SDT may include 2-step RA-SDT and 4-step RA-SDT. SDT for NR may also include CG-SDT for a contention free scenario. For LTE (eMTC and narrowband-IoT), SDT may include EDT during RA (for 4-step RACH). SDT for LTE may also include a PUR for a contention free scenario. CG-SDT for NR is comparable to PUR for LTE. 4-step RA-SDT for NR is comparable to EDT for LTE.

There are some other differences between SDT for NR and SDT for LTE. SDT for NR may involve a normal uplink carrier and a supplemental uplink carrier, while SDT for LTE may involve only the normal uplink carrier. SDT for NR may involve multiple subsequent data transmissions, while SDT for LE may involve only one uplink data transmission and/or one downlink data transmission. SDT for NR may involve a signaling radio bearer and a data radio bearer, while SDT for LTE May involve only a data radio bearer. SDT for NR may involve a non-anchor relocation base station and an anchor relocation base station, while SDT for LTE may involve only an anchor relocation base station.

As indicated above, FIG. 4 is provided as an example. Other examples may differ from what is described with regard to FIG. 4.

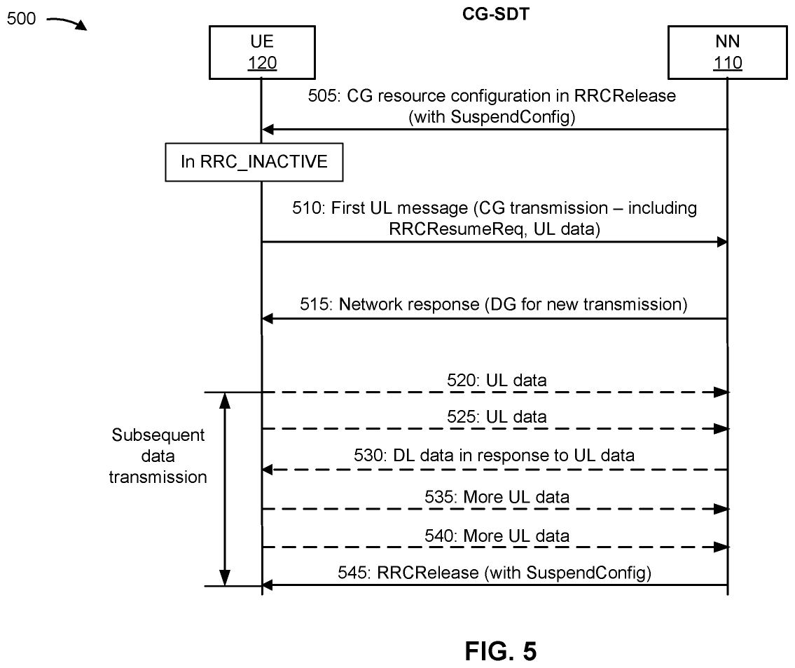

FIG. 5 is a diagram illustrating an example 500 of CG-SDT, in accordance with the present disclosure. As shown in FIG. 4, a network node 110 and a UE 120 may communicate with one another to perform a CG SDT procedure.

As shown by reference number 505, the network node 110 may transmit, and the UE 120 may receive, a CG resource configuration in an RRC release message (e.g., RRCRelease with a suspend configuration indication). The RRC release message may also be used to reconfigure or release the CG-SDT resources while the UE 120 is in an RRC_INACTIVE state. The UE 110 may enter an RRC_INACTIVE state. As shown by reference number 510, the UE 120 may transmit a first UL message. The first UL message may be a CG transmission that includes an RRC resume request and UL data. As shown by reference number 515, the network node 110 may transmit a network response, which may include a dynamic grant (DG) for a new transmission.

As part of a subsequent data transmission part, the UE 120 may transmit uplink data, as shown by reference numbers 520 and 525. As shown by reference number 530, the network node 110 may transmit DL data in response to the UL data. As shown by reference numbers 535 and 540, the UE 120 may transmit more UL data. As shown by reference number 545, the network node 110 may transmit another RRC release message.

As indicated above, FIG. 5 is provided as an example. Other examples may differ from what is described with regard to FIG. 5.

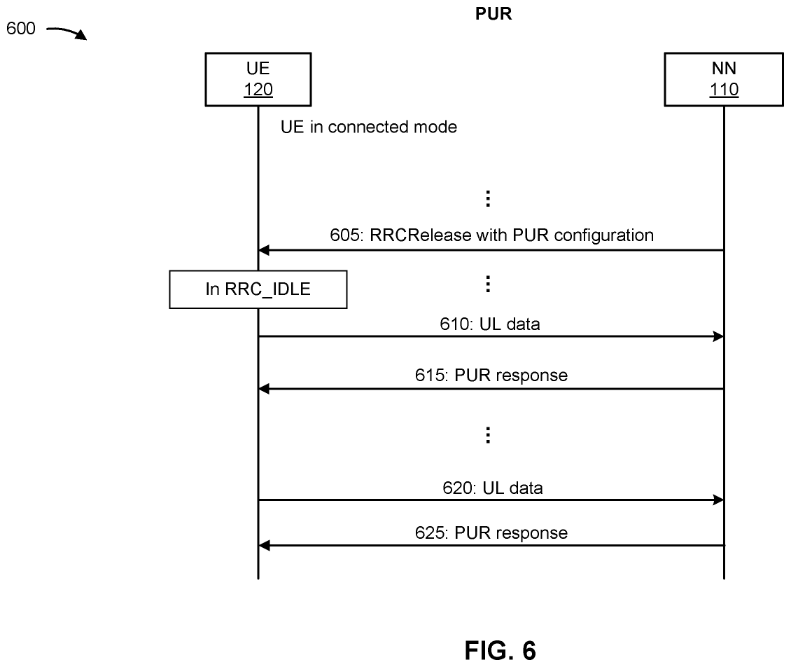

FIG. 6 is a diagram illustrating an example 600 of a PUR procedure, in accordance with the present disclosure.

A UE may use a PUR procedure to transmit uplink data without a connection to the network. A typical use case of PUR includes the UE reporting small size sensor data once every few seconds to the network. Since the overhead is avoided for extra steps for connection establishment or UL synchronization, PUR can help an idle/inactive UE to reduce power consumption. PUR may be more applicable to stationary or low mobility UEs.

PUR resource configuration parameters may be provided by the network node 110 in an RRC release (RRCRelease) message to the UE 120, as shown by reference number 605. As shown by reference number 610, the UE 120 may transmit UL data on a PUR. After the network node 110 receives the UL data from the UE 120 on the PUR, the network node 110 may transmit a PUR response to the UE 120, as shown by reference number 615. In some aspects, the PUR response may include a Layer 1 (L1) acknowledgement (ACK) to indicate whether the UL transmission by the UE 120 using PUR is successfully decoded by the network node 110. The PUR response may include a timing advance command to adjust an UL timing of the UE 120. The PUR response may include an adjustment of the PUR configuration. The PUR response may include an indication for the UE 120 to stop using PUR.

As shown by reference number 620, the UE 120 may transmit UL data again on a PUR. As shown by reference number 625, the network node 110 may transmit a PUR response.

As indicated above, FIG. 6 is provided as an example. Other examples may differ from what is described with regard to FIG. 6.

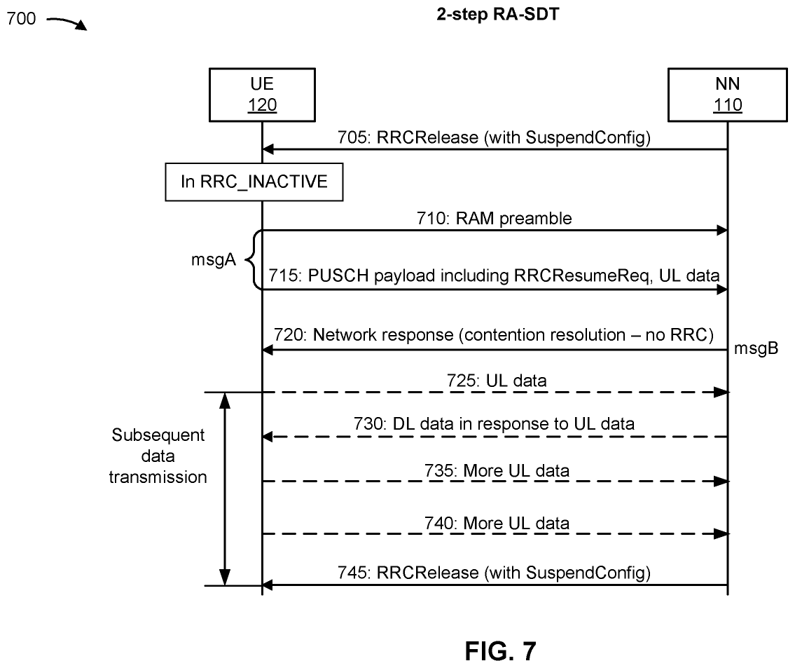

FIG. 7 is a diagram illustrating an example 700 of a 2-step RA-SDT procedure, in accordance with the present disclosure.

A 2-step RACH procedure may be applied to RA-SDT in the RRC_INACTIVE state. The network node 110 may transmit, and the UE 120 may receive, one or more synchronization signal blocks (SSBs) and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the two-step random access procedure, such as one or more parameters for transmitting a random access message (RAM) and/or receiving a random access response (RAR) to the RAM.

As shown by reference number 705, the network node 110 may transmit, and the UE 120 may receive, an RRC release message (e.g., RRCRelease with a suspend configuration indication). The UE 120 may enter an RRC_INACTIVE state. As shown by reference number 710, the UE 120 may transmit a RAM preamble as part of a msgA. In some aspects, a RAM may be referred to as message A, msgA, a first message, or an initial message in a two-step random access procedure. Furthermore, in some aspects, the RAM preamble may be referred to as a message A preamble, a msgA preamble, a preamble, or a physical random access channel (PRACH) preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, uplink control information (UCI), and/or a PUSCH transmission). As shown by reference number 715, as part of the msgA, the UE 120 may transmit a PUSCH payload that includes an RRC resume request and UL data.

The network node 110 may receive the RAM preamble transmitted by the UE 120. If the network node 110 successfully receives and decodes the RAM preamble, the network node 110 may then receive and decode the RAM payload. As shown by reference number 720, the network node 110 may transmit a network response (sometimes referred to as an RAR message). As shown, the network node 110 may transmit the network response as part of a second step of the 2-step random access procedure. In some aspects, the network response may be referred to as message B, msgB, or a second message in a 2-step RACH procedure. The network response may include some or all of the contents of message 2 (msg2) and message 4 (msg4) of a 4-step RACH procedure. For example, the network response may include the detected PRACH preamble identifier, the detected UE identifier, a timing advance value, and/or contention resolution information.

As part of a subsequent data transmission part, the UE 120 may transmit uplink data, as shown by reference number 725. As shown by reference number 730, the network node 110 may transmit DL data in response to the UL data. As shown by reference number 735 and 740, the UE 120 may transmit more UL data. As shown by reference number 745, the network node 110 may transmit another RRC release message.

In the subsequent data transmission (after the completion of an RA procedure), the UE 120 may monitor for dynamic UL grants and DL assignments by a cell radio network temporary identifier (C-RNTI) in a separate common search space (CSS) (if configured) in RA-SDT. The RRC release message may be transmitted at the end to terminate the SDT procedure with respect to the RRC signaling. It is up to the network to transmit another RRC message for the SDT procedure termination.

As indicated above, FIG. 7 is provided as an example. Other examples may differ from what is described with regard to FIG. 7.

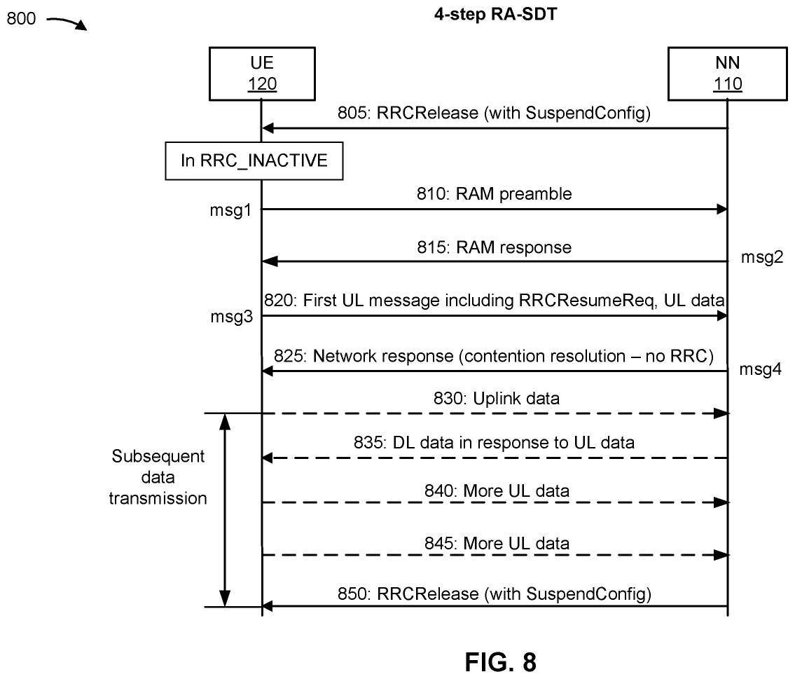

FIG. 8 is a diagram illustrating an example 800 of a 4-step RA-SDT procedure, in accordance with the present disclosure.

A 4-step RACH procedure may be applied to RA-SDT in the RRC_INACTIVE state. As shown by reference number 805, the network node 110 may transmit, and the UE 120 may receive, an RRC release message (e.g., RRCRelease with a suspend configuration indication). The UE 120 may enter an RRC_INACTIVE state.

As shown by reference number 810, the UE 120 may transmit a RAM preamble. The message that includes the preamble may be referred to as a message 1, msg1, MSG1, a first message, or an initial message in a 4-step RACH procedure. The RAM may include a random access preamble identifier (ID).

As shown by reference number 815, the network node 110 may transmit a RAM response (RAR) as a reply to the preamble. The message that includes the RAM response may be referred to as message 2, msg2, MSG2, or a second message in a 4-step RACH procedure. In some aspects, the RAM response may indicate the detected random access preamble ID (e.g., received from the UE 120 in msg1). Additionally, or alternatively, the RAR may indicate a resource allocation to be used by the UE 120 to transmit message 3 (msg3).

As shown by reference number 820, the UE 120 may transmit a first UL message that includes an RRC resume request and UL data. The first UL message may be referred to as message 3, msg3, MSG3, or a third message of a 4-step RACH procedure. In some aspects, the RRC connection request may include a UE identifier, UCI, and/or a PUSCH communication (e.g., an RRC connection request).

As shown by reference number 825, the network node 110 may transmit a network response (for contention resolution). The network response may be referred to as message 4, msg4, MSG4, or a fourth message of a 4-step RACH procedure. In some aspects, the network response may include an RRC connection setup message with the detected UE identifier, a timing advance value, and/or contention resolution information.

As part of a subsequent data transmission part, the UE 120 may transmit uplink data, as shown by reference number 830. As shown by reference number 835, the network node 110 may transmit DL data in response to the UL data. As shown by reference number 840 and 845, the UE 120 may transmit more UL data. As shown by reference number 850, the network node 110 may transmit another RRC release message.

In the subsequent data transmission (after the completion of an RA procedure), the UE 120 may monitor for dynamic UL grants and DL assignments by a C-RNTI in a separate CSS (if configured) in RA-SDT. The RRC release message may be transmitted at the end to terminate the SDT procedure with respect to the RRC signaling. It is up to the network to transmit another RRC message for the SDT procedure termination.

As indicated above, FIG. 8 is provided as an example. Other examples may differ from what is described with regard to FIG. 8.

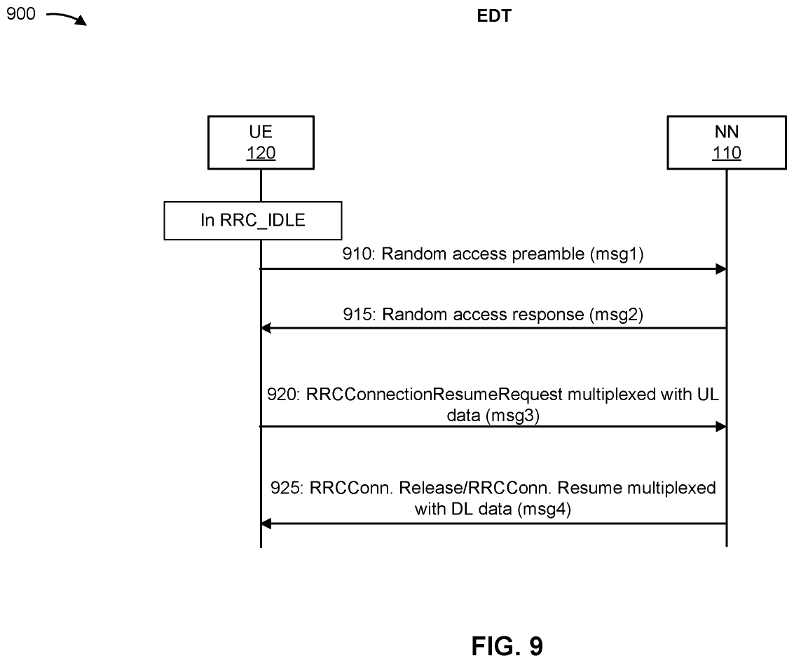

FIG. 9 is a diagram illustrating an example 900 of EDT, in accordance with the present disclosure.

A UE may use EDT only with a 4-step RACH procedure and in RRC_IDLE.

As shown by reference number 910, the UE 120 may transmit a random access preamble (msg1). After the network node 110 receives the UL data, the network node 110 may transmit a random access response (msg2) to the UE 120, as shown by reference number 915.

As shown by reference number 920, the UE 120 may transmit an RRC connection resume request multiplexed with UL data (msg3). As shown by reference number 925, the network node 110 may transmit an RRC connection release or resume message multiplexed with DL data (msg4).

As indicated above, FIG. 9 is provided as an example. Other examples may differ from what is described with regard to FIG. 9.

In some scenarios, multiple UEs may be transmitting SDT data. In some aspects, the SDT transmissions of multiple UEs may be multiplexed at the base station so that SDT transmissions from multiple UEs may occupy the same frequency-time resources. However, this multiplexing may cause interference at the base station.

According to various aspects described herein, a UE may apply an OCC to an SDT data transmission. The OCC may be used to multiplex the signal in the same time resources. The data transmissions from UEs may be cover coded across repetitions in an orthogonal manner using an OCC. The OCC may help mitigate interference at the base station. In this way, multiple access schemes may be used to multiplex multiple UEs, which increases throughput or capacity. The number of UEs that can be multiplexed simultaneously may be governed by a multiplexing order.

In some aspects, an OCC may be used in different SDT transmission schemes for NR and LTE (cMTC and NB-IoT). For example, an OCC may be used for CG-SDT (NR), RA-SDT with 2 step RACH (NR), RA-SDT with 4 step RACH (NR), and/or PUR (LTE) or EDT (LTE). By applying an OCC to SDT, EDT, or PUR, the throughput of UEs may increase significantly. This will result in low latency, low overhead, power-efficient, and high-throughput communications.

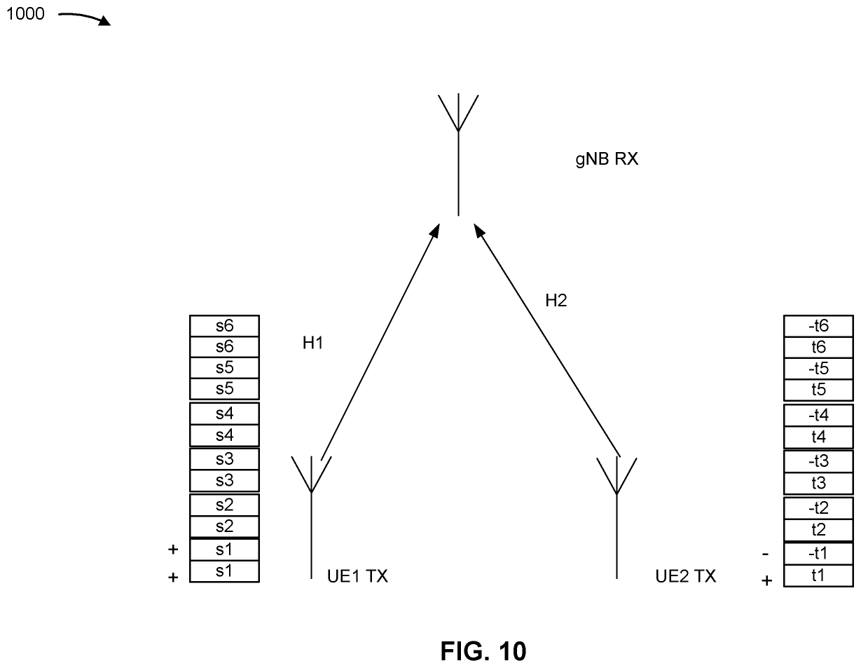

FIG. 10 is a diagram illustrating an example 1000 of a frequency domain OCC multiplexing of two UEs, in accordance with the present disclosure.

As shown in FIG. 10, for the frequency domain OCC multiplexing of two UE, a first UE (e.g., UE1 Tx) may transmit to a network node (e.g., gNB Rx) over a first channel (H1), a second UE (e.g., UE2 Tx) may transmit to the network node over a second channel (H2), and the network node may receive from both the first UE and the second UE. The first UE may transmit symbols to the network node with a repetition factor of two. For example, the first UE may transmit a first symbol (s1) two times, a second symbol (s2) two times, and so on, where both the first symbol and the second symbol may be positively signed symbols (e.g., +s1, +s1, +s2, +s2, and so on) due to positive OCCs being applied. The second UE may also transmit signed symbols to the network node with a repetition factor of two. For example, the second UE may transmit a first symbol (t1) two times, a second symbol (t2) two times, and so on, where the first symbol and the second symbol may be associated with both a positively signed symbol and a negatively signed symbol (e.g., +t1, −t1, +t2, −t2, and so on) due to both positive and negative OCCs being applied.

The network node, at a first resource element (or first tone), may receive +s1H1 and +t1H2. The network node, at a second resource element (or second tone), may receive +s1H1 and −t1H2, and so on. The network node may add symbols for the first resource element and the second resource element. The network node may perform (s1H1+t1H2)+ (s1H1-t1H2), which results in 2s1H1. The network node may obtain 2s1H1 (e.g., 2 times s1 times H1) from the first UE. With an estimate of H1, e.g., via a DMRS signal, the network node may estimate s1. The network node may also subtract symbols for the first resource element and the second resource element. The network node may perform s1H1+t1H2−(s1H1−t1H2), which results in 2t1H2. The network node may obtain 2t1H2 (e.g., 2 times t1) from the second UE. With an estimate of H2, e.g., via a DMRS signal, the network node may estimate t1.

As indicated above, FIG. 10 is provided as an example. Other examples may differ from what is described with regard to FIG. 10.

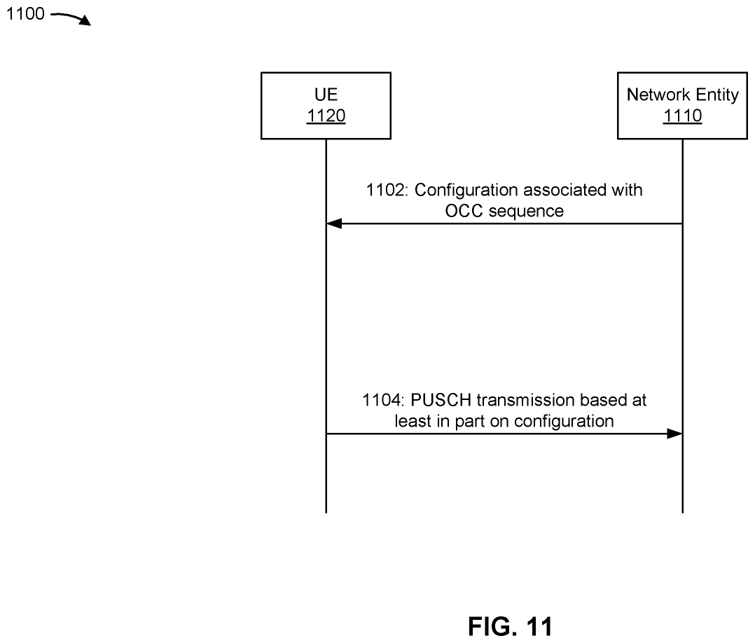

FIG. 11 is a diagram illustrating an example 1000 associated with frequency domain OCC-based PUSCH multiplexing, in accordance with the present disclosure. As shown in FIG. 11, example 1100 includes communication between a UE 1120 (e.g., UE 120) and a network entity 1110 (e.g., network node 110). In some aspects, the UE and the network node may be included in a wireless network, such as wireless network 100.

An OCC may include an OCC sequence. As shown by reference number 1102, the UE may receive, from the network node, a configuration associated with an OCC sequence. The UE may receive, from the network node, the configuration via a MAC CE, RRC signaling, or DCI. The configuration may be associated with a CP-OFDM waveform or a DFT-s-OFDM waveform. The configuration may indicate a randomization pattern for selecting OCC sequences over a period of time. The configuration may be associated with an OCC configuration for a DMRS, and a same OCC multiplexing pattern or a same OCC sequence, in relation to the DMRS, may be applied to a PUSCH transmission by the UE. The configuration may be associated with a frequency domain OCC-based PUSCH multiplexing. The OCC sequence may be a Hadamard sequence. The OCC sequence may be associated with a vector of a discrete Fourier transform (DFT) matrix. The OCC sequence may be a Zadoff-Chu sequence. The OCC sequence may be a computer-generated sequence, or a cyclic shifted version of the computer-generated sequence.

As shown by reference number 1104, the UE may transmit, to the network node, the PUSCH transmission based at least in part on the configuration. The OCC sequence may be applied to one or more symbols associated with the PUSCH transmission. The UE may use the OCC sequence, indicated by the configuration, for the PUSCH transmission. The configuration may enable the PUSCH transmission to be multiplexed with another PUSCH transmission by another UE. For example, the UE may be a first UE and the PUSCH transmission may be a first PUSCH transmission. Based at least in part on the configuration, a second UE may transmit a second PUSCH transmission to the network node, where the first PUSCH transmission and the second PUSCH transmission may be multiplexed PUSCH transmissions. The multiplexed PUSCH transmissions may be PUCCH repetitions that allow multiple UEs to be multiplexed with OCCs, which may increase a system capacity because more UEs are supported with the same resource.

As indicated above, FIG. 11 is provided as an example. Other examples may differ from what is described with regard to FIG. 11.

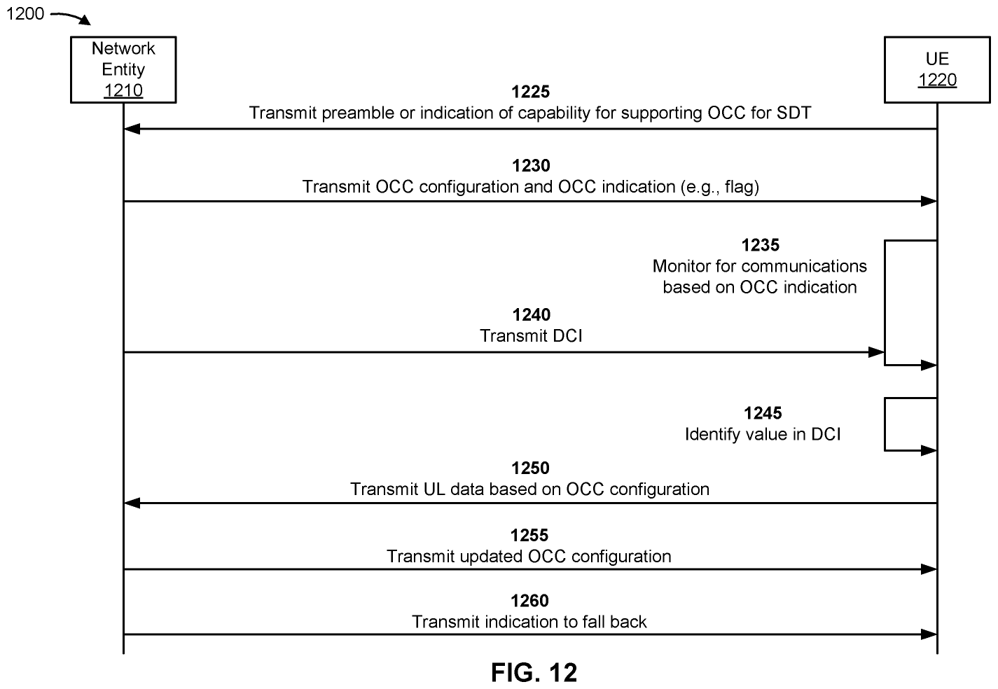

FIG. 12 is a diagram illustrating an example 1200 associated with an OCC configuration for SDT, in accordance with the present disclosure. As shown in FIG. 12, a network entity 1210 (e.g., network node 110) and a UE 1220 (e.g., UE 120) may communicate with one another via a wireless network (e.g., wireless communication network 100).

As shown by reference number 1225, the UE 1220 may transmit a preamble or an indication of a UE capability for supporting an OCC for SDT. In some aspects, the indication may be for supporting an OCC for CG-SDT or a PUR. In some aspects, the preamble may be associated with supporting an OCC for 2-step RA-SDT, 4-step RA-SDT, or EDT. In some aspects, the preamble or a RACH occasion (RO) may be from a resource pool associated with OCC support for the UEs. In some aspects, the network entity 1210 may transmit a SIB that enables SDT transmission (e.g., 2-step RA-SDT, 4-step RA-SDT) with an OCC or EDT transmission with an OCC.

As shown by reference number 1230, the network entity 1210 may transmit an OCC configuration. In some aspects, the network entity 1210 may transmit the OCC configuration in an RAR or a msgB. The RAR or the msgB may be for an OCC UE and may be different than an RAR or a msgB for a non-OCC UE. The OCC configuration may enable the UE to transmit uplink data during transmission of the CG-SDT using an OCC. The OCC configuration may enable the UE to transmit uplink data during transmission of the PUR using an OCC. The OCC configuration may enable the UE to transmit uplink data during transmission of the RA-SDT using an OCC. The OCC configuration may enable the UE to transmit uplink data during transmission of the EDT using an OCC.

In some aspects, the network entity 1210 may also transmit an OCC indication. The OCC indication may be a flag. The OCC indication may indicate how to monitor a downlink in association with OCC support. The OCC configuration and/or the OCC indication may be based at least in part on the capability of the UE 1220. In some aspects, the network entity 1210 may transmit the OCC configuration in one or more RRC messages for CG-SDT and/or PUR.

As shown by reference number 1235, the UE 1220 may monitor for communications based at least in part on the OCC indication. In some aspects, the UE 1220 may monitor a DL in a first search space if OCC is supported and monitor the DL in a second search space if OCC is not supported. In some aspects, the UE 1220 may monitor for downlink communications based at least in part on the preamble that was transmitted.

As shown by reference number 1240, the network entity 1210 may transmit DCI. As shown by reference number 1245, the UE 1220 may identify a value in the DCI. The UE 1220 may identify values in DCI according to a first manner if OCC is supported and identify values in the DCI according to a second manner if OCC is not supported. DCI for an OCC-supported UE may be different than DCI for a non-OCC-supported UE. As shown by reference number 1250, the UE 1220 may transmit UL data based at least in part on the OCC configuration.

As shown by reference number 1255, the network entity 1210 may transmit an updated OCC configuration. In some aspects, the updated OCC configuration may change one or more of the multiplexing order, the OCC codeword for the multiplexing order, or the OCC indication. The updated configuration may disable use of an OCC for a CG-SDT or a PUR. The updated configuration may enable one or more of a new multiplexing order, a new OCC codeword for the new multiplexing order, or a new OCC indication for a next CG-SDT or a next PUR. In some aspects, the updated OCC configuration may change one or more of the multiplexing order, the OCC codeword for the multiplexing order, or the OCC indication. The updated OCC configuration may disable use of an OCC for an RA-SDT or an EDT. The updated OCC configuration may enable one or more of a new multiplexing order, a new OCC codeword for the new multiplexing order, or a new OCC indication for a next RA-SDT or a next EDT.

In some aspects, as shown by reference number 1260, the network entity 1210 may transmit an indication to fall back to SDT without an OCC if SDT transmission has failed. For example, the network entity 1210 may transmit an indication to fall back to a transmission of the CG-SDT or the PUR without an OCC based at least in part on a determination that a transmission of the CG-SDT or the PUR with an OCC has failed. In another example, the network entity 1210 may transmit an indication to fall back to a transmission of the RA-SDT or the EDT without an OCC based at least in part on a determination that a transmission of the RA-SDT or the EDT with an OCC has failed.

As indicated above, FIG. 12 is provided as an example. Other examples may differ from what is described with respect to FIG. 12.

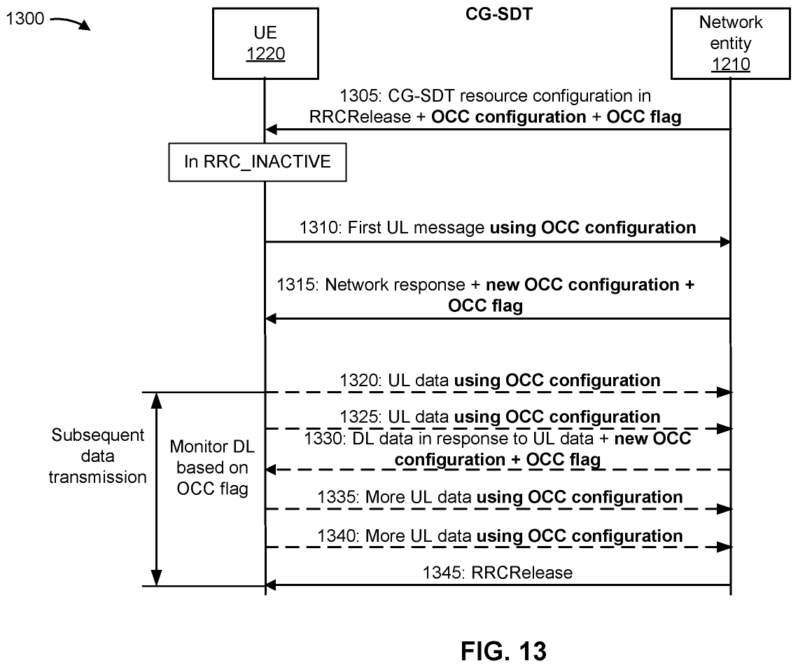

FIG. 13 is a diagram illustrating an example 1300 of using an OCC for CG-SDT, in accordance with the present disclosure.

In some aspects, the network entity 1210 may enable UEs with OCC capabilities to transmit uplink data during CG-SDT using an OCC. Accordingly, the network entity 1210 may include OCC information in a CG-SDT resource configuration message (e.g., within BWP-UplinkDedicatedSDT) for the UE 1220. For example, as shown by reference number 1305, the network entity 1210 may transmit a CG-SDT resource configuration in an RRC release message, where the CG-SDT resource configuration includes an OCC configuration. The OCC configuration may indicate a particular multiplexing order (associated with the multiplexing of uplink data by multiple UEs) and a particular OCC codeword for the multiplexing order. The OCC configuration and the OCC codeword may be associated with a CG resource. The CG resources of UEs that use an OCC may be maintained separately from CG resources that do not use an OCC. The network entity 1210 may ensure that resources from OCC UEs and non-OCC UEs do not overlap. In some aspects, the UE 1220 may provide information to the network entity 1210 about a UE capability for supporting OCC for CG-SDT. After receiving the RRC release message, the UE 1220 may enter an RRC inactive state.

In some aspects, the network entity 1210 may also enable UEs with OCC capabilities to monitor a downlink in CG-SDT differently than UEs without OCC capabilities. The CG-SDT resource configuration may include or may be transmitted in the RRC release message with an OCC indication, such as an OCC flag. The OCC flag may indicate how the UE 1220 is to monitor subsequent downlink transmissions. Because UEs that support the use of an OCC (OCC UEs) may monitor a downlink differently than UEs that do not support OCC (non-OCC UEs), there may be different options in which an OCC supporting UE may monitor the downlink.

In a first option, if the OCC flag is enabled, the UE 1220 may decode DCI in a different manner as compared to a non-OCC UE. In a second option, if the OCC flag is enabled, a DCI for an OCC UE may be different than a DCI for a non-OCC UE (e.g., DCI for OCC and non-OCC have different lengths). In a third option, the network entity 1210 may separate the search space for downlink monitoring between OCC UEs and non-OCC UEs. This means that the search space may be partitioned to have a search space for SDT with OCC UEs and a search space for SDT with non-OCC UEs. This partitioning may be indicated in sdt-CG-SearchSpace in PDCCH-ConfigCommon information element (IE) within a SIB. If the OCC flag is enabled, the OCC UEs may monitor only the search space that was partitioned for OCC UEs. The UE 1220 may monitor the downlink based at least in part on the OCC flag.

As shown by reference number 1310, the UE 1220 may transmit a first uplink message with an OCC using the OCC configuration. As shown by reference number 1315, the network entity 1210 may provide a new OCC configuration during subsequent downlink responses to support schemes, such as OCC hopping. The network entity 1210 may provide another OCC flag. In some aspects, the network entity 1210 may not configure OCC in the first transmission but may enable OCC for coming UL transmissions (e.g., retransmissions).

As shown by reference numbers 1320 and 1325, as part of subsequent data transmission, the UE 1220 may transmit uplink data using the OCC configuration. As shown by reference number 1330, the network entity 1210 may transmit downlink data in response to the uplink data with a new OCC configuration. The network entity 1210 may also transmit a new OCC configuration and another OCC flag. As shown by reference numbers 1335 and 1340, as part of the subsequent data transmission, the UE 1220 may transmit more uplink data with an OCC using the OCC configuration. As shown by reference number 1345, the UE 1220 may transmit an RRC release message.

By transmitting an OCC configuration, the network entity 1210 may enable the UE 1220 to transmit uplink data using the OCC configuration, which includes transmitting the uplink data using an OCC for CG-SDT. As a result, the network entity 1210 may receive multiplexed data from the UE 1220 and other UEs that do not interfere. This improves throughput and reduces latency for CG-SDT. By using an OCC indication (e.g., OCC flag), the network entity 1210 may indicate how the UE 1220 is to monitor the downlink, which may be different for OCC UEs than for non-OCC UEs. This may improve throughput and reduce latency.

As indicated above, FIG. 13 is provided as an example. Other examples may differ from what is described with regard to FIG. 13.

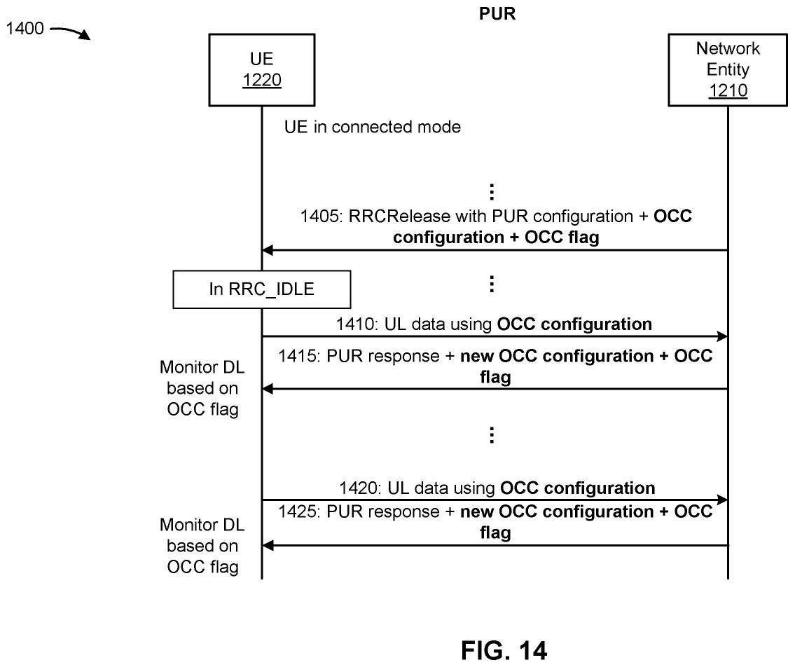

FIG. 14 is a diagram illustrating an example 1400 of using an OCC for PUR, in accordance with the present disclosure.

The UE 1220 may be in a connected mode. In some aspects, the network entity 1210 may enable UEs with OCC capabilities to transmit uplink data during PUR using an OCC. Accordingly, the network entity 1210 may include OCC information in a PUR resource configuration message (e.g., within pur-config IE or pur-config-NB IE) for the UE 1220. For example, as shown by reference number 1405, the network entity 1210 may transmit a PUR configuration in an RRC release message, where the PUR configuration includes an OCC configuration. The OCC configuration may point to a particular multiplexing order (associated with the multiplexing of UL data by multiple UEs) and a particular OCC codeword for the multiplexing order. The OCC configuration and the OCC codeword may be associated with a PUR resource. The CG resources of UEs that use an OCC may be maintained separate from PUR resources that do not use an OCC. The network entity 1210 may ensure that resources from OCC UEs and non-OCC UEs do not overlap. In some aspects, the UE 1220 may provide information to the network entity 1210 about a UE capability for supporting OCC for PUR. After receiving the RRC release message, the UE 1220 may enter an RRC inactive state.

In some aspects, the network entity 1210 may also enable UEs with OCC capabilities to monitor a downlink for a PUR response differently than UEs without OCC capabilities. The PUR configuration may include or may be transmitted in the RRC release message with an OCC indication, such as an OCC flag. The OCC flag may indicate how the UE 1220 is to monitor subsequent downlink transmissions. Because UEs that support the use of an OCC (OCC UEs) may monitor a downlink differently than UEs that do not support OCC (non-OCC UEs), there may be different options in which an OCC-supporting UE may monitor the downlink.

In a first option, if the OCC flag is enabled, the UE 1220 may decode DCI in a different manner as compared to a non-OCC UE. In a second option, if the OCC flag is enabled, a DCI for an OCC UE may be different than a DCI for a non-OCC UE (e.g., DCI for OCC and non-OCC have different lengths). In a third option, the network entity 1210 may separate the search space for downlink monitoring between OCC UEs and non-OCC UEs. This means that the search space may be partitioned to have a search space for PUR with OCC UEs and a search space for PUR with non-OCC UEs. This partitioning may be indicated in pur-config IE or pur-config-NB. If the OCC flag is enabled, the OCC UEs may monitor only the search space that was partitioned for OCC UEs.

As shown by reference number 1410, the UE 1220 may transmit uplink data with a PUR and an OCC using the OCC configuration. As shown by reference number 1415, the network entity 1210 may provide a new OCC configuration in a PUR response. The network entity 1210 may provide another OCC flag. In some aspects, the network entity 1210 may not configure OCC in the first transmission but may enable OCC for coming uplink transmissions (e.g., retransmissions). The UE 1220 may monitor the downlink based at least in part on the OCC flag.

As shown by reference number 1420, the UE 1220 may transmit uplink data with a PUR and an OCC using the OCC configuration. As shown by reference number 1425, the network entity 1210 may transmit downlink data in a PUR response to the uplink data with a new OCC configuration.

By transmitting an OCC configuration, the network entity 1210 may enable the UE 1220 to transmit uplink data using the OCC configuration, which includes transmitting the uplink data using an OCC for CG-SDT. As a result, the network entity 1210 may receive multiplexed data from the UE 1220 and other UEs that do not interfere. This improves throughput and reduces latency for CG-SDT. By using an OCC indication (e.g., OCC flag), the network entity 1210 may indicate how the UE 1220 is to monitor the downlink, which may be different for OCC UEs than for non-OCC UEs. This may improve throughput and reduce latency.

As indicated above, FIG. 14 is provided as an example. Other examples may differ from what is described with regard to FIG. 14.

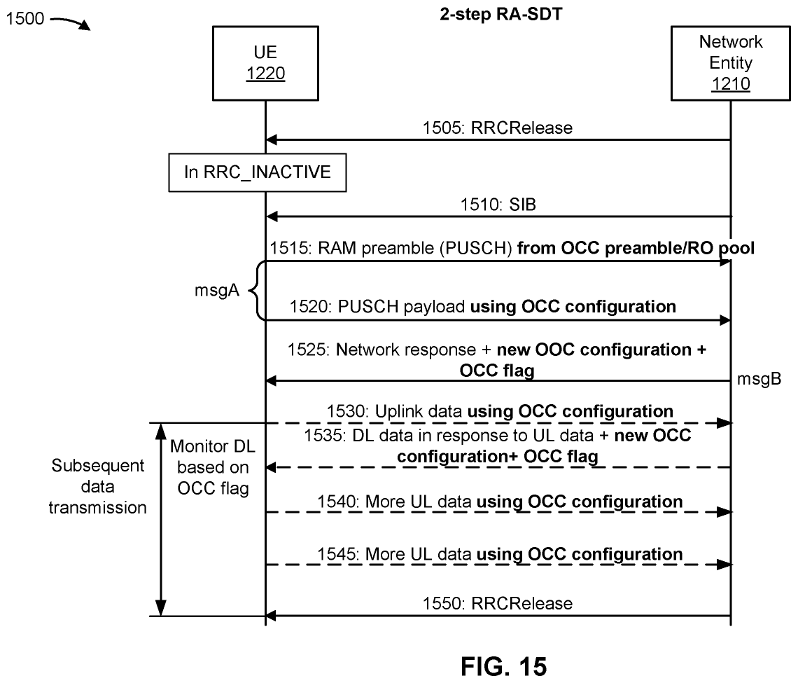

FIG. 15 is a diagram illustrating an example 1500 of using an OCC for 2-step RA-SDT, in accordance with the present disclosure.

In some aspects, the network entity 1210 may enable UEs with OCC capabilities to transmit uplink data using an OCC during 2-step RA-SDT. As shown by reference number 1505, the network entity 1210 may transmit an RRC release message. The UE 1220 may enter an RRC inactive state. As shown by reference number 1510, the network entity 1210 may transmit a SIB that enables OCC.

The network entity 1210 may partition preambles or ROs for OCC UEs and preambles or ROs for non-OCC UEs. As shown by reference number 1515, the UE 1220 may transmit a RAM preamble (in a PUSCH message) that comes from a resource pool for preambles that support OCC UEs and/or from a resource pool for ROs that support OCC UEs. The SIB may indicate the partitioning. When the UE 1220 selects the preamble from the OCC preamble resource pool, this selection may serve as an OCC indication (e.g., OCC flag) that indicates how the UE is to monitor a downlink for an upcoming RAR (an RAR for OCC UEs may be different than an RAR for non-OCC UEs), such as a msgB. The selected preamble from the OCC preamble resource pool may also map to an OCC configuration that points to a particular multiplexing order and a particular OCC codeword for that multiplexing order. The RAR may include the OCC configuration (with other content).

As shown by reference number 1520, the UE 1220 may transmit a PUSCH payload using the OCC configuration. If the OCC configuration is associated with a particular preamble, the UE 1220 may use the same OCC configuration for data, or the UE 1220 may be reassigned an OCC configuration in a msgB. If no OCC configuration is associated with a preamble, the UE 1220 may use the one indicated in a msgB. As shown by reference number 1525, the network entity 1210 may transmit a network response (msgB) that includes a new OCC configuration and an OCC flag. The OCC flag may be optional.

The OCC configuration and the OCC codeword may be associated with a 2-step RA-SDT resource. The 2-step RA-SDT resources of UEs that use an OCC may be maintained separate from the 2-step RA-SDT resources that do not use an OCC. The network entity 1210 may ensure that resources from OCC UEs and non-OCC UEs do not overlap. In some aspects, the UE 1220 may provide information to the network entity 1210 about a UE capability for supporting OCC for 2-step RA-SDT.

In some aspects, the network entity 1210 may also enable UEs with OCC capabilities to monitor a downlink in 2-step RA-SDT differently than UEs without OCC capabilities. In some aspects, the selection of the preamble from the OCC preamble resource pool may serve as an OCC flag. Because UEs that support the use of an OCC (OCC UEs) may monitor a downlink differently than UEs that do not support OCC (non-OCC UEs), there may be different options in which an OCC supporting UE may monitor the downlink.

In a first option, if the OCC flag is enabled, the UE 1220 may decode DCI in a different manner as compared to a non-OCC UE. In a second option, if the OCC flag is enabled, a DCI for an OCC UE may be different than a DCI for a non-OCC UE (e.g., DCI for OCC and non-OCC have different lengths). In a third option, the network entity 1210 may separate the search space for downlink monitoring between OCC UEs and non-OCC UEs. This means that the search space may be partitioned to have a search space for SDT with OCC UEs and a search space for SDT with non-OCC UEs. This partitioning may be indicated in sdt-SearchSpace in a PDCCH-ConfigCommon IE within the SIB. If the OCC flag is enabled, the OCC UEs may monitor only the search space that was partitioned for OCC UEs. The UE 1220 may monitor the downlink based at least in part on the OCC flag.

As shown by reference number 1530, the UE 1220 may transmit uplink data with an OCC using the OCC configuration. As shown by reference number 1535, the network entity 1210 may transmit downlink data in response to the uplink data and provide a new OCC configuration. The network entity 1210 may provide another OCC flag. In some aspects, the network entity 1210 may not configure OCC in the first transmission but may enable OCC for coming uplink transmissions (e.g., retransmissions). As shown by reference numbers 1540 and 1545, as part of subsequent data transmission, the UE 1220 may transmit more uplink data using the OCC configuration. As shown by reference number 1550, the UE 1220 may transmit an RRC release message.

By using a preamble from an OCC preamble resource pool, the UE 1220 may transmit uplink data using an OCC for 2-step RA-SDT. As a result, the network entity 1210 may receive multiplexed data from the UE 1220 and other UEs that do not interfere. This improves throughput and reduces latency for 2-step RA-SDT. By using the OCC preamble or an OCC indication (e.g., OCC flag), the network entity 1210 may indicate how the UE 1220 is to monitor the downlink, which may be different for OCC UEs than for non-OCC UEs. This may improve throughput and reduce latency.

As indicated above, FIG. 15 is provided as an example. Other examples may differ from what is described with regard to FIG. 15.

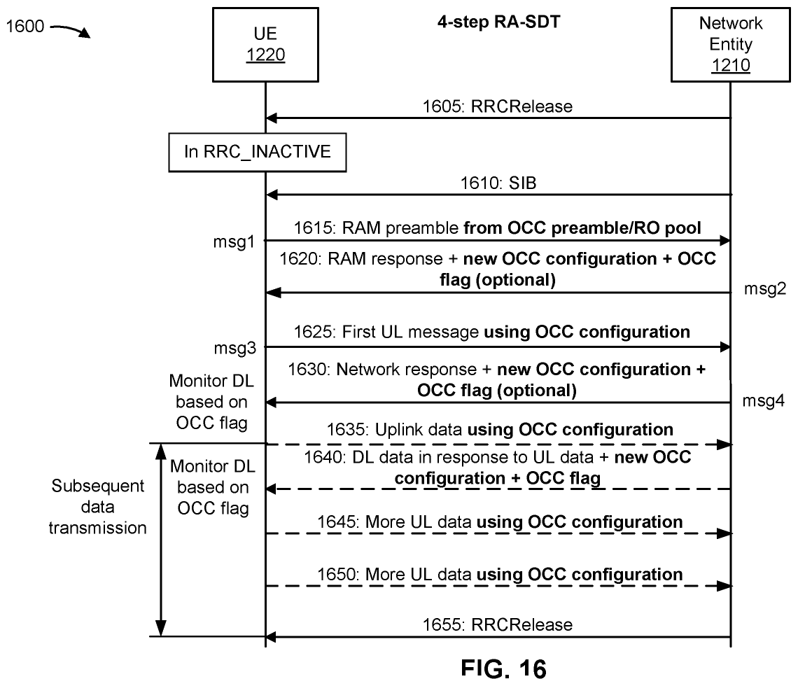

FIG. 16 is a diagram illustrating an example 1600 of using an OCC for 4-step RA-SDT, in accordance with the present disclosure.

In some aspects, the network entity 1210 may enable UEs with OCC capabilities to transmit uplink data using an OCC during 4-step RA-SDT. As shown by reference number 1605, the network entity 1210 may transmit an RRC release message. The UE 1220 may enter an RRC inactive state. As shown by reference number 1610, the network entity 1210 may transmit a SIB that enables OCC.

The network entity 1210 may partition preambles or ROs for OCC UEs and preambles or ROs for non-OCC UEs. As shown by reference number 1615, the UE 1220 may transmit a RAM preamble (in a PUSCH message) that comes from a resource pool for preambles that support OCC UEs and/or from a resource pool for ROs that support OCC UEs. The SIB may indicate the partitioning. When the UE 1220 selects the preamble from the OCC preamble resource pool, this selection may serve as an OCC indication (e.g., OCC flag) that indicates how the UE is to monitor a downlink for an upcoming RAM response (an RAR for OCC UEs may be different than an RAR for non-OCC UEs), such as a msg2. The selected preamble from the OCC preamble resource pool may also map to an OCC configuration that points to a particular multiplexing order and a particular OCC codeword for that multiplexing order. The RAR may include the OCC configuration (with other content).

As shown by reference number 1620, the network entity 1210 may transmit a network response (msg2) that includes an OCC configuration and an OCC flag. The OCC flag may be optional. As shown by reference number 1625, the UE 1220 may transmit a first uplink message using the OCC configuration. If the OCC configuration is associated with a particular preamble, the UE 1220 may use the same OCC configuration for data, or the UE 1220 may be reassigned an OCC configuration in a msg2. If no OCC configuration is associated with a preamble, the UE 1220 may use the one indicated in a msg2.

The OCC configuration and the OCC codeword may be associated with a 4-step RA-SDT resource. The 4-step RA-SDT resources of UEs that use an OCC may be maintained separate from the 4-step RA-SDT resources that do not use an OCC. The network entity 1210 may ensure that resources from OCC UEs and non-OCC UEs do not overlap. In some aspects, the UE 1220 may provide information to the network entity 1210 about a UE capability for supporting OCC for 4-step RA-SDT.

In some aspects, the network entity 1210 may also enable UEs with OCC capabilities to monitor a downlink in 4-step RA-SDT differently than UEs without OCC capabilities. In some aspects, the selection of the preamble from the OCC preamble resource pool may serve as an OCC flag. Because UEs that support the use of an OCC (OCC UEs) may monitor a downlink differently than UEs that do not support OCC (non-OCC UEs), there may be different options in which an OCC supporting UE may monitor the downlink.

In a first option, if the OCC flag is enabled, the UE 1220 may decode DCI in a different manner as compared to a non-OCC UE. In a second option, if the OCC flag is enabled, a DCI for an OCC UE may be different than a DCI for a non-OCC UE (e.g., DCI for OCC and non-OCC have different lengths). In a third option, the network entity 1210 may separate the search space for downlink monitoring between OCC UEs and non-OCC UEs. This means that the search space may be partitioned to have a search space for SDT with OCC UEs and a search space for SDT with non-OCC UEs. This partitioning may be indicated in sdt-SearchSpace in a PDCCH-ConfigCommon IE within the SIB. If the OCC flag is enabled, the OCC UEs may monitor only the search space that was partitioned for OCC UEs. The UE 1220 may monitor the downlink based at least in part on the OCC flag. As shown by reference number 1630, the network entity 1210 may transmit a network response with a new OCC configuration and another OCC flag.

As shown by reference number 1635, the UE 1220 may transmit uplink data with an OCC using the OCC configuration. As shown by reference number 1640, the network entity 1210 may transmit downlink data in response to the uplink data and provide a new OCC configuration. The network entity 1210 may provide another OCC flag. In some aspects, the network entity 1210 may not configure OCC in the first transmission but may enable OCC for coming uplink transmissions (e.g., retransmissions). As shown by reference numbers 1645 and 1650, as part of subsequent data transmission, the UE 1220 may transmit more uplink data using the OCC configuration. As shown by reference number 1655, the UE 1220 may transmit an RRC release message.

By using a preamble from an OCC preamble resource pool, the UE 1220 may transmit uplink data using an OCC for 4-step RA-SDT. As a result, the network entity 1210 may receive multiplexed data from the UE 1220 and other UEs that do not interfere. This improves throughput and reduces latency for 4-step RA-SDT. By using the OCC preamble or an OCC indication (e.g., OCC flag), the network entity 1210 may indicate how the UE 1220 is to monitor the downlink, which may be different for OCC UEs than for non-OCC UEs. This may improve throughput and reduce latency.

As indicated above, FIG. 16 is provided as an example. Other examples may differ from what is described with regard to FIG. 16.

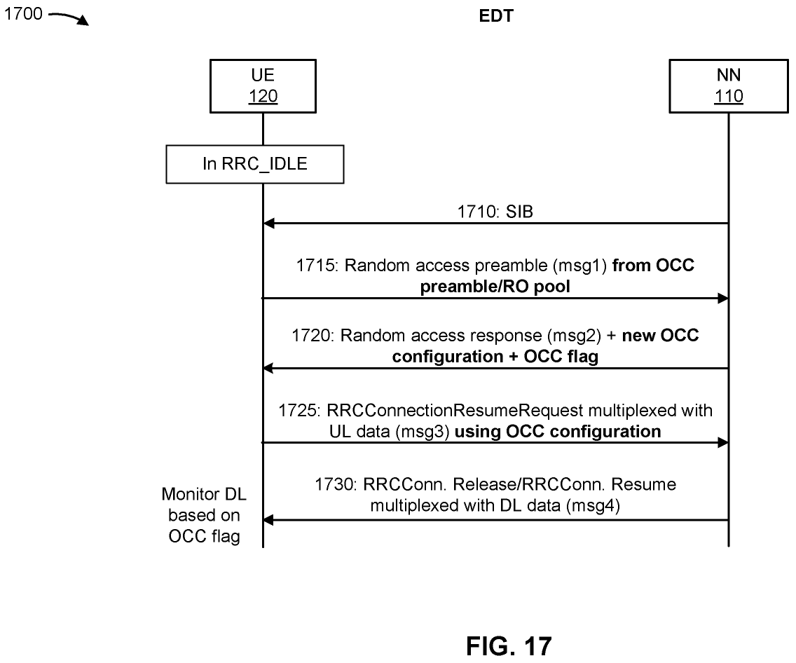

FIG. 17 is a diagram illustrating an example 1700 of using an OCC for EDT, in accordance with the present disclosure.

In some aspects, the network entity 1210 may enable UEs with OCC capabilities to transmit uplink data using an OCC during EDT. The UE 1220 may be in an idle state. As shown by reference number 1710, the network entity 1210 may transmit a SIB that enables OCC.

The network entity 1210 may partition preambles or ROs for OCC UEs and preambles or ROs for non-OCC UEs. As shown by reference number 1715, the UE 1220 may transmit a RAM preamble (in a msg1) that comes from a resource pool for preambles that support OCC UEs and/or from a resource pool for ROs that support OCC UEs. The SIB may indicate the partitioning. When the UE 1220 selects the preamble from the OCC preamble resource pool, this selection may serve as an OCC indication (e.g., OCC flag) that indicates how the UE is to monitor a downlink for an upcoming RAR (an RAR for OCC UEs may be different than an RAR for non-OCC UEs), such as a msg2. The selected preamble from the OCC preamble resource pool may also map to an OCC configuration that points to a particular multiplexing order and a particular OCC codeword for that multiplexing order. The RAR may include the OCC configuration (with other content).

If the OCC configuration is associated with a particular preamble, the UE 1220 may use the same OCC configuration for data, or the UE 1220 may be reassigned an OCC configuration in a msg2. If no OCC configuration is associated with a preamble, the UE 1220 may use the one indicated in a msg2. As shown by reference number 1720, the network entity 1210 may transmit a network response (msg2) that includes a new OCC configuration and an OCC flag. The OCC flag may be optional.

The OCC configuration and the OCC codeword may be associated with an EDT resource. The EDT resources of UEs that use an OCC may be maintained separate from the EDT resources that do not use an OCC. The network entity 1210 may ensure that resources from OCC UEs and non-OCC UEs do not overlap. In some aspects, the UE 1220 may provide information to the network entity 1210 about a UE capability for supporting OCC for EDT.

In some aspects, the network entity 1210 may also enable UEs with OCC capabilities to monitor a downlink in an EDT differently than UEs without OCC capabilities. In some aspects, the selection of the preamble from the OCC preamble resource pool may serve as an OCC flag. Because UEs that support the use of an OCC (OCC UEs) may monitor a downlink differently than UEs that do not support OCC (non-OCC UEs), there may be different options in which an OCC supporting UE may monitor the downlink.

In a first option, if the OCC flag is enabled, the UE 1220 may decode DCI in a different manner as compared to a non-OCC UE. In a second option, if the OCC flag is enabled, a DCI for an OCC UE may be different than a DCI for a non-OCC UE (e.g., DCI for OCC and non-OCC have different lengths). In a third option, the network entity 1210 may separate the search space for downlink monitoring between OCC UEs and non-OCC UEs. This means that the search space may be partitioned to have a search space for SDT with OCC UEs and a search space for SDT with non-OCC UEs. This partitioning may be indicated in an PRACH-Config IE with changing PDCCH search space parameters or NPRACH-ConfigSIB-NB by changing PDCCH search space parameters. If the OCC flag is enabled, the OCC UEs may monitor only the search space that was partitioned for OCC UEs. The UE 1220 may monitor the downlink based at least in part on the OCC flag.

As shown by reference number 1725, the UE 1220 may transmit uplink data (in msg3) with an OCC using the OCC configuration. The uplink data may be multiplexed with an RRC connected resume request message. As shown by reference number 1730, the network entity 1210 may transmit downlink data in response to the uplink data and provide a new OCC configuration. The downlink data may be multiplexed with an RRC connection release message or an RRC connection resume message.

By using a preamble from an OCC preamble resource pool, the UE 1220 may transmit uplink data using an OCC for EDT. As a result, the network entity 1210 may receive multiplexed data from the UE 1220 and other UEs that do not interfere. This improves throughput and reduces latency for EDT. By using the OCC preamble or an OCC indication (e.g., OCC flag), the network entity 1210 may indicate how the UE 1220 is to monitor the downlink, which may be different for OCC UEs than for non-OCC UEs. This may improve throughput and reduce latency.

As indicated above, FIG. 17 is provided as an example. Other examples may differ from what is described with regard to FIG. 17.

FIG. 18 is a diagram illustrating an example process 1800 performed, for example, at a UE or an apparatus of a UE, in accordance with the present disclosure. Example process 1800 is an example where the apparatus or the UE (e.g., UE 120, UE 1220) performs operations associated with OCC support for CG-SDT.

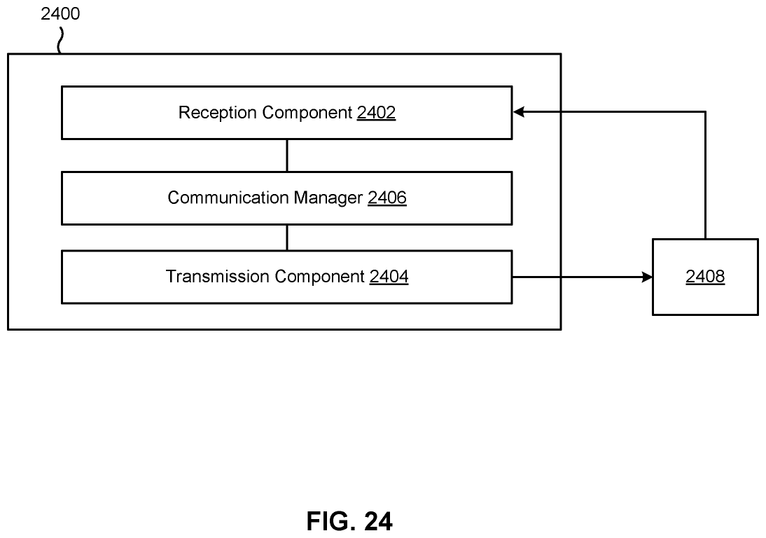

As shown in FIG. 18, in some aspects, process 1800 may include transmitting an indication of a capability for supporting an OCC for a CG-SDT (block 1810). For example, the UE (e.g., using transmission component 2404 and/or communication manager 2406, depicted in FIG. 24) may transmit an indication of a capability for supporting an OCC for a CG-SDT, as described above.

As further shown in FIG. 18, in some aspects, process 1800 may include receiving an OCC configuration that indicates a multiplexing order and an OCC codeword for the multiplexing order, and an OCC indication that indicates how to monitor a downlink in association with supporting the OCC for the CG-SDT (block 1820). For example, the UE (e.g., using reception component 2402 and/or communication manager 2406, depicted in FIG. 24) may receive an OCC configuration that indicates a multiplexing order and an OCC codeword for the multiplexing order, and an OCC indication that indicates how to monitor a downlink in association with supporting the OCC for the CG-SDT, as described above.

Process 1800 may include additional aspects, such as any single aspect or any combination of aspects described below and/or in connection with one or more other processes described elsewhere herein.

In a first aspect, process 1800 includes monitoring for downlink communications based at least in part on the OCC indication.

In a second aspect, alone or in combination with the first aspect, receiving the OCC configuration includes receiving the OCC configuration in one or more RRC messages for CG-SDT.

In a third aspect, alone or in combination with one or more of the first and second aspects, the OCC configuration enables the UE to transmit uplink data during transmission of the CG-SDT using an OCC.

In a fourth aspect, alone or in combination with one or more of the first through third aspects, process 1800 includes identifying values in DCI according to a first manner if OCC is supported and identifying values in the DCI according to a second manner if OCC is not supported.

In a fifth aspect, alone or in combination with one or more of the first through fourth aspects, DCI for an OCC-supported UE is different than DCI for a non-OCC-supported UE.

In a sixth aspect, alone or in combination with one or more of the first through fifth aspects, process 1800 includes monitoring a downlink in a first search space if OCC is supported and monitoring the downlink in a second search space if OCC is not supported.

In a seventh aspect, alone or in combination with one or more of the first through sixth aspects, process 1800 includes transmitting uplink data based at least in part on the OCC configuration.

In an eighth aspect, alone or in combination with one or more of the first through seventh aspects, process 1800 includes receiving an updated OCC configuration that changes one or more of the multiplexing order, the OCC codeword for the multiplexing order, or the OCC indication, disabling use of an OCC for a CG-SDT, or enabling one or more of a new multiplexing order, a new OCC codeword for the new multiplexing order, or a new OCC indication for a next CG-SDT.

Although FIG. 18 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

FIG. 19 is a diagram illustrating an example process 1900 performed, for example, at a UE or an apparatus of a UE, in accordance with the present disclosure. Example process 1900 is an example where the apparatus or the UE (e.g., UE 120, UE 1220) performs operations associated with OCC support for PUR.

As shown in FIG. 19, in some aspects, process 1900 may include transmitting an indication of a capability for supporting an OCC for a PUR (block 1910). For example, the UE (e.g., using transmission component 2404 and/or communication manager 2406, depicted in FIG. 24) may transmit an indication of a capability for supporting an OCC for a PUR, as described above.

As further shown in FIG. 19, in some aspects, process 1900 may include receiving an OCC configuration that indicates a multiplexing order and an OCC codeword for the multiplexing order, and an OCC indication that indicates how to monitor a downlink in association with supporting the OCC for the PUR (block 1920). For example, the UE (e.g., using reception component 2402 and/or communication manager 2406, depicted in FIG. 24) may receive an OCC configuration that indicates a multiplexing order and an OCC codeword for the multiplexing order, and an OCC indication that indicates how to monitor a downlink in association with supporting the OCC for the PUR, as described above.

Process 1900 may include additional aspects, such as any single aspect or any combination of aspects described below and/or in connection with one or more other processes described elsewhere herein.

In a first aspect, process 1900 includes monitoring for downlink communications based at least in part on the OCC indication.

In a second aspect, alone or in combination with the first aspect, receiving the OCC configuration includes receiving the OCC configuration in one or more RRC messages for PUR.

In a third aspect, alone or in combination with one or more of the first and second aspects, the OCC configuration enables the UE to transmit uplink data during transmission of the PUR using an OCC.

In a fourth aspect, alone or in combination with one or more of the first through third aspects, process 1900 includes identifying values in DCI according to a first manner if OCC is supported and identifying values in the DCI according to a second manner if OCC is not supported.

In a fifth aspect, alone or in combination with one or more of the first through fourth aspects, DCI for an OCC-supported UE is different than DCI for a non-OCC-supported UE.

In a sixth aspect, alone or in combination with one or more of the first through fifth aspects, process 1900 includes monitoring a downlink in a first search space if OCC is supported and monitoring the DL in a second search space if OCC is not supported.

In a seventh aspect, alone or in combination with one or more of the first through sixth aspects, process 1900 includes transmitting uplink data based at least in part on the OCC configuration.

In an eighth aspect, alone or in combination with one or more of the first through seventh aspects, process 1900 includes receiving an updated OCC configuration that changes one or more of the multiplexing order, the OCC codeword for the multiplexing order, or the OCC indication, disabling use of an OCC for a PUR, or enabling one or more of a new multiplexing order, a new OCC codeword for the new multiplexing order, or a new OCC indication for a next PUR.

Although FIG. 19 shows example blocks of process 1900, in some aspects, process 1900 may include additional blocks, fewer blocks, different blocks, or differently arranged blocks than those depicted in FIG. 19. Additionally, or alternatively, two or more of the blocks of process 1900 may be performed in parallel.

FIG. 20 is a diagram illustrating an example process 2000 performed, for example, at a UE or an apparatus of a UE, in accordance with the present disclosure. Example process 2000 is an example where the apparatus or the UE (e.g., UE 120, UE 1220) performs operations associated with OCC support for an RA-SDT with a 2-step RACH procedure.

As shown in FIG. 20, in some aspects, process 2000 may include transmitting a preamble associated with OCC support for transmission of an RA-SDT with a 2-step RACH procedure (block 2010). For example, the UE (e.g., using transmission component 2404 and/or communication manager 2406, depicted in FIG. 24) may transmit a preamble associated with OCC support for transmission of an RA-SDT with a 2-step RACH procedure, as described above.

As further shown in FIG. 20, in some aspects, process 2000 may include receiving an OCC configuration that indicates a multiplexing order and an OCC codeword for the multiplexing order (block 2020). For example, the UE (e.g., using reception component 2402 and/or communication manager 2406, depicted in FIG. 24) may receive an OCC configuration that indicates a multiplexing order and an OCC codeword for the multiplexing order, as described above.

Process 2000 may include additional aspects, such as any single aspect or any combination of aspects described below and/or in connection with one or more other processes described elsewhere herein.

In a first aspect, process 2000 includes monitoring for downlink communications based at least in part on the preamble that was transmitted.

In a second aspect, alone or in combination with the first aspect, process 2000 includes receiving a SIB that enables SDT transmission with an OCC.

In a third aspect, alone or in combination with one or more of the first and second aspects, the preamble or an RO is from a resource pool associated with OCC support for UEs.

In a fourth aspect, alone or in combination with one or more of the first through third aspects, process 2000 includes receiving an OCC indication that indicates how to monitor a downlink in association with OCC support.

In a fifth aspect, alone or in combination with one or more of the first through fourth aspects, the OCC configuration enables the UE to transmit uplink data during transmission of an RA-SDT using an OCC.

In a sixth aspect, alone or in combination with one or more of the first through fifth aspects, the OCC configuration is based at least in part on the preamble, and the transmission is based at least in part on the OCC configuration.

In a seventh aspect, alone or in combination with one or more of the first through sixth aspects, receiving the OCC configuration includes receiving the OCC configuration in an RAR or a msgB, and the transmission is based at least in part on the OCC configuration.

In an eighth aspect, alone or in combination with one or more of the first through seventh aspects, the RAR or the msgB is for an OCC UE and is different than an RAR or a msgB for a non-OCC UE.

In a ninth aspect, alone or in combination with one or more of the first through eighth aspects, the OCC configuration is based at least in part on the preamble, and the transmission is based at least in part on the OCC configuration.

In a tenth aspect, alone or in combination with one or more of the first through ninth aspects, receiving the OCC configuration includes receiving the OCC configuration in an RAR, and the transmission is based at least in part on the OCC configuration.

In an eleventh aspect, alone or in combination with one or more of the first through tenth aspects, the RAR is for an OCC UE and is different than an RAR for a non-OCC UE.

In a twelfth aspect, alone or in combination with one or more of the first through eleventh aspects, process 2000 includes receiving an updated OCC configuration that changes one or more of the multiplexing order, the OCC codeword for the multiplexing order, and the OCC indication, disabling use of an OCC for an RA-SDT, or enabling one or more of a new multiplexing order, a new OCC codeword for the new multiplexing order, or a new OCC indication for a next RA-SDT.

Although FIG. 20 shows example blocks of process 2000, in some aspects, process 2000 may include additional blocks, fewer blocks, different blocks, or differently arranged blocks than those depicted in FIG. 20. Additionally, or alternatively, two or more of the blocks of process 2000 may be performed in parallel.

FIG. 21 is a diagram illustrating an example process 2100 performed, for example, at a UE or an apparatus of a UE, in accordance with the present disclosure. Example process 2100 is an example where the apparatus or the UE (e.g., UE 120, UE 1220) performs operations associated with OCC support for an RA-SDT with a 4-step RACH procedure.

As shown in FIG. 21, in some aspects, process 2100 may include transmitting a preamble associated with OCC support for transmission of an RA-SDT with a 4-step RACH procedure (block 2110). For example, the UE (e.g., using transmission component 2404 and/or communication manager 2406, depicted in FIG. 24) may transmit a preamble associated with OCC support for transmission of an RA-SDT with a 4-step RACH procedure, as described above.

As further shown in FIG. 21, in some aspects, process 2100 may include receiving an OCC configuration that indicates a multiplexing order and an OCC codeword for the multiplexing order (block 2120). For example, the UE (e.g., using reception component 2402 and/or communication manager 2406, depicted in FIG. 24) may receive an OCC configuration that indicates a multiplexing order and an OCC codeword for the multiplexing order, as described above.

Process 2100 may include additional aspects, such as any single aspect or any combination of aspects described below and/or in connection with one or more other processes described elsewhere herein.

In a first aspect, process 2100 includes monitoring for downlink communications based at least in part on the preamble that was transmitted.

In a second aspect, alone or in combination with the first aspect, process 2100 includes receiving a SIB that enables SDT transmission with an OCC.

In a third aspect, alone or in combination with one or more of the first and second aspects, the preamble or an RO is from a resource pool associated with OCC support for UEs.

In a fourth aspect, alone or in combination with one or more of the first through third aspects, process 2100 includes receiving an OCC indication that indicates how to monitor a downlink in association with OCC support.

In a fifth aspect, alone or in combination with one or more of the first through fourth aspects, the OCC configuration enables the UE to transmit uplink data during transmission of an RA-SDT using an OCC.

In a sixth aspect, alone or in combination with one or more of the first through fifth aspects, the OCC configuration is based at least in part on the preamble, and the transmission is based at least in part on the OCC configuration.

In a seventh aspect, alone or in combination with one or more of the first through sixth aspects, receiving the OCC configuration includes receiving the OCC configuration in an RAR or a msgB, and the transmission is based at least in part on the OCC configuration.

In an eighth aspect, alone or in combination with one or more of the first through seventh aspects, the RAR or the msgB is for an OCC UE and is different than an RAR or a msgB for a non-OCC UE.

In a ninth aspect, alone or in combination with one or more of the first through eighth aspects, the OCC configuration is based at least in part on the preamble, and the transmission is based at least in part on the OCC configuration.

In a tenth aspect, alone or in combination with one or more of the first through ninth aspects, receiving the OCC configuration includes receiving the OCC configuration in an RAR, and the transmission is based at least in part on the OCC configuration.

In an eleventh aspect, alone or in combination with one or more of the first through tenth aspects, the RAR is for an OCC UE and is different than an RAR for a non-OCC UE.

In a twelfth aspect, alone or in combination with one or more of the first through eleventh aspects, process 2100 includes receiving an updated OCC configuration that changes one or more of the multiplexing order, the OCC codeword for the multiplexing order, and the OCC indication, disabling use of an OCC for an RA-SDT or an EDT, or enabling one or more of a new multiplexing order, a new OCC codeword for the new multiplexing order, or a new OCC indication for a next RA-SDT or a next EDT.

Although FIG. 21 shows example blocks of process 2100, in some aspects, process 2100 may include additional blocks, fewer blocks, different blocks, or differently arranged blocks than those depicted in FIG. 21. Additionally, or alternatively, two or more of the blocks of process 2100 may be performed in parallel.

FIG. 22 is a diagram illustrating an example process 2200 performed, for example, at a UE or an apparatus of a UE, in accordance with the present disclosure. Example process 2200 is an example where the apparatus or the UE (e.g., UE 120, UE 1220) performs operations associated with OCC support for EDT.

As shown in FIG. 22, in some aspects, process 2200 may include transmitting a preamble associated with OCC support for transmission of an EDT (block 2210). For example, the UE (e.g., using transmission component 2404 and/or communication manager 2406, depicted in FIG. 24) may transmit a preamble associated with OCC support for transmission of an EDT, as described above.

As further shown in FIG. 22, in some aspects, process 2200 may include receiving an OCC configuration that indicates a multiplexing order and an OCC codeword for the multiplexing order (block 2220). For example, the UE (e.g., using reception component 2402 and/or communication manager 2406, depicted in FIG. 24) may receive an OCC configuration that indicates a multiplexing order and an OCC codeword for the multiplexing order, as described above.

Process 2200 may include additional aspects, such as any single aspect or any combination of aspects described below and/or in connection with one or more other processes described elsewhere herein.

In a first aspect, process 2200 includes monitoring for downlink communications based at least in part on the preamble that was transmitted.

In a second aspect, alone or in combination with the first aspect, process 2200 includes receiving a SIB that enables EDT transmission with an OCC.

In a third aspect, alone or in combination with one or more of the first and second aspects, the preamble or an RO is from a resource pool associated with OCC support for UEs.

In a fourth aspect, alone or in combination with one or more of the first through third aspects, process 2200 includes receiving an OCC indication that indicates how to monitor a downlink in association with OCC support.

In a fifth aspect, alone or in combination with one or more of the first through fourth aspects, the OCC configuration is based at least in part on the preamble, and the transmission is based at least in part on the OCC configuration.

In a sixth aspect, alone or in combination with one or more of the first through fifth aspects, receiving the OCC configuration includes receiving the OCC configuration in an RAR or a msgB, and the transmission is based at least in part on the OCC configuration.

In a seventh aspect, alone or in combination with one or more of the first through sixth aspects, the RAR or the msgB is for an OCC UE and is different than an RAR or a msgB for a non-OCC UE.

In an eighth aspect, alone or in combination with one or more of the first through seventh aspects, the OCC configuration enables the UE to transmit uplink data during transmission of an EDT using an OCC.

In a ninth aspect, alone or in combination with one or more of the first through eighth aspects, the OCC configuration is based at least in part on the preamble, and the transmission is based at least in part on the OCC configuration.

In a tenth aspect, alone or in combination with one or more of the first through ninth aspects, receiving the OCC configuration includes receiving the OCC configuration in an RAR, and the transmission is based at least in part on the OCC configuration.

In an eleventh aspect, alone or in combination with one or more of the first through tenth aspects, the RAR is for an OCC UE and is different than an RAR for a non-OCC UE.

In a twelfth aspect, alone or in combination with one or more of the first through eleventh aspects, process 2200 includes receiving an updated OCC configuration that changes one or more of the multiplexing order, the OCC codeword for the multiplexing order, and the OCC indication, disabling use of an OCC for an EDT, or enabling one or more of a new multiplexing order, a new OCC codeword for the new multiplexing order, or a new OCC indication for a next EDT.

Although FIG. 22 shows example blocks of process 2200, in some aspects, process 2200 may include additional blocks, fewer blocks, different blocks, or differently arranged blocks than those depicted in FIG. 22. Additionally, or alternatively, two or more of the blocks of process 2200 may be performed in parallel.

FIG. 23 is a diagram illustrating an example process 2300 performed, for example, at a network entity or an apparatus of a network entity, in accordance with the present disclosure. Example process 2300 is an example where the apparatus or the network entity (e.g., network node 110, network entity 1210) performs operations associated with OCC support for SDT.

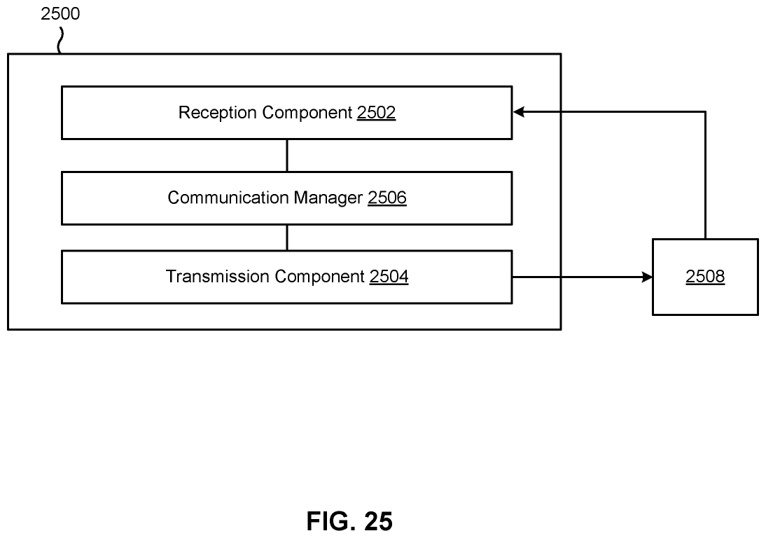

As shown in FIG. 23, in some aspects, process 2300 may include receiving a preamble or a capability indication associated with OCC support for a CG-SDT, a PUR, an RA-SDT with a 4-step RACH procedure, an RA-SDT with a 2-step RACH procedure, or an EDT (block 2310). For example, the network entity (e.g., using reception component 2502 and/or communication manager 2506, depicted in FIG. 25) may receive a preamble or a capability indication associated with OCC support for a CG-SDT, a PUR, an RA-SDT with a 4-step RACH procedure, an RA-SDT with a 2-step RACH procedure, or an EDT, as described above.

As further shown in FIG. 23, in some aspects, process 2300 may include transmitting, based at least in part on the capability indication, an OCC configuration that indicates a multiplexing order and an OCC codeword for the multiplexing order (block 2320). For example, the network entity (e.g., using transmission component 2504 and/or communication manager 2506, depicted in FIG. 25) may transmit, based at least in part on the capability indication, an OCC configuration that indicates a multiplexing order and an OCC codeword for the multiplexing order, as described above.

Process 2300 may include additional aspects, such as any single aspect or any combination of aspects described below and/or in connection with one or more other processes described elsewhere herein.

In a first aspect, process 2300 includes transmitting an OCC indication that indicates whether to monitor a downlink in association with OCC support.

In a second aspect, alone or in combination with the first aspect, resources for OCC support for a CG-SDT, a PUR, an RA-SDT, or an EDT are different than resources for non-OCC support for a CG-SDT, a PUR, an RA-SDT, or an EDT.

In a third aspect, alone or in combination with one or more of the first and second aspects, process 2300 includes transmitting an indication to fall back to a transmission of the CG-SDT or the PUR without an OCC based at least in part on a determination that a transmission of the CG-SDT or the PUR with an OCC has failed.

In a fourth aspect, alone or in combination with one or more of the first through third aspects, process 2300 includes transmitting an indication to fall back to a transmission of the RA-SDT or the EDT without an OCC based at least in part on a determination that a transmission of the RA-SDT or the EDT with an OCC has failed.

In a fifth aspect, alone or in combination with one or more of the first through fourth aspects, process 2300 includes transmitting an updated OCC configuration that changes one or more of the multiplexing order, the OCC codeword for the multiplexing order, and the OCC indication, disabling use of an OCC for a CG-SDT, a PUR, an RA-SDT, or an EDT, or enabling one or more of a new multiplexing order, a new OCC codeword for the new multiplexing order, or a new OCC indication for a next CG-SDT, a next PUR, a next RA-SDT, or a next EDT.

Although FIG. 23 shows example blocks of process 2300, in some aspects, process 2300 may include additional blocks, fewer blocks, different blocks, or differently arranged blocks than those depicted in FIG. 23. Additionally, or alternatively, two or more of the blocks of process 2300 may be performed in parallel.

FIG. 24 is a diagram of an example apparatus 2400 for wireless communication, in accordance with the present disclosure. The apparatus 2400 may be a UE, or a UE may include the apparatus 2400. In some aspects, the apparatus 2400 includes a reception component 2402, a transmission component 2404, and/or a communication manager 2406, which may be in communication with one another (for example, via one or more buses and/or one or more other components). In some aspects, the communication manager 2406 is the communication manager 140 described in connection with FIG. 1. As shown, the apparatus 2400 may communicate with another apparatus 2408, such as a UE or a network node (such as a CU, a DU, an RU, or a base station), using the reception component 2402 and the transmission component 2404.

In some aspects, the apparatus 2400 may be configured to perform one or more operations described herein in connection with FIGS. 1-17. Additionally, or alternatively, the apparatus 2400 may be configured to perform one or more processes described herein, such as process 1800 of FIG. 18, process 1900 of FIG. 19, process 2000 of FIG. 20, process 2100 of FIG. 21, process 2200 of FIG. 22, process 2300 of FIG. 23, or a combination thereof. In some aspects, the apparatus 2400 and/or one or more components shown in FIG. 24 may include one or more components of the UE described in connection with FIG. 2. Additionally, or alternatively, one or more components shown in FIG. 24 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2402 may receive communications, such as reference signals, control information, data communications, or a combination thereof, from the apparatus 2408. The reception component 2402 may provide received communications to one or more other components of the apparatus 2400. In some aspects, the reception component 2402 may perform signal processing on the received communications (such as filtering, amplification, demodulation, analog-to-digital cancellation, or decoding, among other examples), and may provide the processed signals to the one or more other components of the apparatus 2400. In some aspects, the reception component 2402 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 2404 may transmit communications, such as reference signals, control information, data communications, or a combination thereof, to the apparatus 2408. In some aspects, one or more other components of the apparatus 2400 may generate communications and may provide the generated communications to the transmission component 2404 for transmission to the apparatus 2408. In some aspects, the transmission component 2404 may perform signal processing on the generated communications (such as filtering, amplification, modulation, digital-to-analog conversion, multiplexing, interleaving, mapping, or encoding, among other examples), and may transmit the processed signals to the apparatus 2408. In some aspects, the transmission component 2404 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 2404 may be co-located with the reception component 2402 in one or more transceivers.

The communication manager 2406 may support operations of the reception component 2402 and/or the transmission component 2404. For example, the communication manager 2406 may receive information associated with configuring reception of communications by the reception component 2402 and/or transmission of communications by the transmission component 2404. Additionally, or alternatively, the communication manager 2406 may generate and/or provide control information to the reception component 2402 and/or the transmission component 2404 to control reception and/or transmission of communications.

In some aspects, the transmission component 2404 may transmit an indication of a capability for supporting an OCC for a CG-SDT or a PUR. The reception component 2402 may receive an OCC configuration that indicates a multiplexing order and an OCC codeword for the multiplexing order, and an OCC indication that indicates how to monitor a downlink in association with supporting the OCC for the CG-SDT or the PUR. The communication manager 2406 may monitor for downlink communications based at least in part on the OCC indication.

The communication manager 2406 may identify values in DCI according to a first manner if OCC is supported and identify values in the DCI according to a second manner if OCC is not supported. The communication manager 2406 may monitor a downlink in a first search space if OCC is supported and monitor the DL in a second search space if OCC is not supported. The transmission component 2404 may transmit uplink data based at least in part on the OCC configuration.

The reception component 2402 may receive an updated OCC configuration that changes one or more of the multiplexing order, the OCC codeword for the multiplexing order, or the OCC indication, disables use of an OCC for a CG-SDT or a PUR, or enables one or more of a new multiplexing order, a new OCC codeword for the new multiplexing order, or a new OCC indication for a next CG-SDT or a next PUR.

In some aspects, the transmission component 2404 may transmit a preamble associated with OCC support for transmission of an RA-SDT with a 4-step RACH procedure, an RA-SDT with a 2-step RACH procedure, or an EDT. The reception component 2402 may receive an OCC configuration that indicates a multiplexing order and an OCC codeword for the multiplexing order.

The communication manager 2406 may monitor for downlink communications based at least in part on the preamble that was transmitted. The reception component 2402 may receive a SIB that enables SDT transmission with an OCC or EDT transmission with an OCC. The reception component 2402 may receive an OCC indication that indicates how to monitor a downlink in association with OCC support.

The reception component 2402 may receive an updated OCC configuration that changes one or more of the multiplexing order, the OCC codeword for the multiplexing order, and the OCC indication, disables use of an OCC for an RA-SDT or an EDT, or enables one or more of a new multiplexing order, a new OCC codeword for the new multiplexing order, or a new OCC indication for a next RA-SDT or a next EDT.

The number and arrangement of components shown in FIG. 24 are provided as an example. In practice, there may be additional components, fewer components, different components, or differently arranged components than those shown in FIG. 24. Furthermore, two or more components shown in FIG. 24 may be implemented within a single component, or a single component shown in FIG. 24 may be implemented as multiple, distributed components. Additionally, or alternatively, a set of (one or more) components shown in FIG. 24 may perform one or more functions described as being performed by another set of components shown in FIG. 24.

FIG. 25 is a diagram of an example apparatus 2500 for wireless communication, in accordance with the present disclosure. The apparatus 2500 may be a network entity, or a network entity may include the apparatus 2500. In some aspects, the apparatus 2500 includes a reception component 2502, a transmission component 2504, and/or a communication manager 2506, which may be in communication with one another (for example, via one or more buses and/or one or more other components). In some aspects, the communication manager 2506 is the communication manager 150 described in connection with FIG. 1. As shown, the apparatus 2500 may communicate with another apparatus 2508, such as a UE or a network node (such as a CU, a DU, an RU, or a base station), using the reception component 2502 and the transmission component 2504.

In some aspects, the apparatus 2500 may be configured to perform one or more operations described herein in connection with FIGS. 1-17. Additionally, or alternatively, the apparatus 2500 may be configured to perform one or more processes described herein, such as process 2300 of FIG. 23. In some aspects, the apparatus 2500 and/or one or more components shown in FIG. 25 may include one or more components of the network entity described in connection with FIG. 2. Additionally, or alternatively, one or more components shown in FIG. 25 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2502 may receive communications, such as reference signals, control information, data communications, or a combination thereof, from the apparatus 2508. The reception component 2502 may provide received communications to one or more other components of the apparatus 2500. In some aspects, the reception component 2502 may perform signal processing on the received communications (such as filtering, amplification, demodulation, analog-to-digital cancellation, or decoding, among other examples), and may provide the processed signals to the one or more other components of the apparatus 2500. In some aspects, the reception component 2502 may include one or more antennas, one or more modems, one or more demodulators, one or more MIMO detectors, one or more receive processors, one or more controllers/processors, one or more memories, or a combination thereof, of the network entity described in connection with FIG. 2.

The transmission component 2504 may transmit communications, such as reference signals, control information, data communications, or a combination thereof, to the apparatus 2508. In some aspects, one or more other components of the apparatus 2500 may generate communications and may provide the generated communications to the transmission component 2504 for transmission to the apparatus 2508. In some aspects, the transmission component 2504 may perform signal processing on the generated communications (such as filtering, amplification, modulation, digital-to-analog conversion, multiplexing, interleaving, mapping, or encoding, among other examples), and may transmit the processed signals to the apparatus 2508. In some aspects, the transmission component 2504 may include one or more antennas, one or more modems, one or more modulators, one or more transmit MIMO processors, one or more transmit processors, one or more controllers/processors, one or more memories, or a combination thereof, of the network entity described in connection with FIG. 2. In some aspects, the transmission component 2504 may be co-located with the reception component 2502 in one or more transceivers.

The communication manager 2506 may support operations of the reception component 2502 and/or the transmission component 2504. For example, the communication manager 2506 may receive information associated with configuring reception of communications by the reception component 2502 and/or transmission of communications by the transmission component 2504. Additionally, or alternatively, the communication manager 2506 may generate and/or provide control information to the reception component 2502 and/or the transmission component 2504 to control reception and/or transmission of communications.

The reception component 2502 may receive a preamble or a capability indication associated with OCC support for a CG-SDT, a PUR, an RA-SDT with a 4-step RACH procedure, an RA-SDT with a 2-step RACH procedure, or an EDT. The transmission component 2504 may transmit, based at least in part on the capability indication, an OCC configuration that indicates a multiplexing order and an OCC codeword for the multiplexing order. The transmission component 2504 may transmit an OCC indication that indicates whether to monitor a downlink in association with OCC support.

The transmission component 2504 may transmit an indication to fall back to a transmission of the CG-SDT or the PUR without an OCC based at least in part on a determination that a transmission of the CG-SDT or the PUR with an OCC has failed.

The transmission component 2504 may transmit an indication to fall back to a transmission of the RA-SDT or the EDT without an OCC based at least in part on a determination that a transmission of the RA-SDT or the EDT with an OCC has failed.

The transmission component 2504 may transmit an updated OCC configuration that changes one or more of the multiplexing order, the OCC codeword for the multiplexing order, and the OCC indication, disables use of an OCC for a CG-SDT, a PUR, an RA-SDT, or an EDT, or enables one or more of a new multiplexing order, a new OCC codeword for the new multiplexing order, or a new OCC indication for a next CG-SDT, a next PUR, a next RA-SDT, or a next EDT.

The number and arrangement of components shown in FIG. 25 are provided as an example. In practice, there may be additional components, fewer components, different components, or differently arranged components than those shown in FIG. 25. Furthermore, two or more components shown in FIG. 25 may be implemented within a single component, or a single component shown in FIG. 25 may be implemented as multiple, distributed components. Additionally, or alternatively, a set of (one or more) components shown in FIG. 25 may perform one or more functions described as being performed by another set of components shown in FIG. 25.

The following provides an overview of some Aspects of the present disclosure:

Aspect 1: A method of wireless communication performed by a user equipment (UE), comprising: transmitting an indication of a capability for supporting an orthogonal cover code (OCC) for a configured grant (CG) small data transmission (SDT) or a preconfigured uplink resource (PUR); and receiving an OCC configuration that indicates a multiplexing order and an OCC codeword for the multiplexing order, and an OCC indication that indicates how to monitor a downlink in association with supporting the OCC for the CG-SDT or the PUR.

Aspect 2: The method of Aspect 1, further comprising monitoring for downlink communications based at least in part on the OCC indication.

Aspect 3: The method of any of Aspects 1-2, wherein receiving the OCC configuration includes receiving the OCC configuration in one or more radio resource control messages for CG-SDT and PUR.

Aspect 4: The method of any of Aspects 1-3, wherein the OCC configuration enables the UE to transmit uplink data during transmission of the CG-SDT using an OCC.

Aspect 5: The method of any of Aspects 1-3, wherein the OCC configuration enables the UE to transmit uplink data during transmission of the PUR using an OCC.

Aspect 6: The method of any of Aspects 1-5, further comprising identifying values in downlink control information (DCI) according to a first manner if OCC is supported and identifying values in the DCI according to a second manner if OCC is not supported.

Aspect 7: The method of any of Aspects 1-6, wherein downlink control information (DCI) for an OCC-supported UE is different than DCI for a non-OCC-supported UE.

Aspect 8: The method of any of Aspects 1-7, further comprising monitoring a downlink (DL) in a first search space if OCC is supported and monitoring the DL in a second search space if OCC is not supported.

Aspect 9: The method of any of Aspects 1-8, further comprising transmitting uplink data based at least in part on the OCC configuration.

Aspect 10: The method of any of Aspects 1-9, further comprising receiving an updated OCC configuration that: changes one or more of the multiplexing order, the OCC codeword for the multiplexing order, or the OCC indication, disables use of an OCC for a CG-SDT or a PUR, or enables one or more of a new multiplexing order, a new OCC codeword for the new multiplexing order, or a new OCC indication for a next CG-SDT or a next PUR.

Aspect 11: A method of wireless communication performed by a user equipment (UE), comprising: transmitting a preamble associated with orthogonal cover code (OCC) support for transmission of a random access (RA) small data transmission (SDT) with a 4-step random access channel (RACH) procedure, an RA-SDT with a 2-step RACH procedure, or an early data transmission (EDT); and receiving an OCC configuration that indicates a multiplexing order and an OCC codeword for the multiplexing order.

Aspect 12: The method of Aspect 11, further comprising monitoring for downlink communications based at least in part on the preamble that was transmitted.

Aspect 13: The method of any of Aspects 11-12, further comprising receiving a system information block (SIB) that enables SDT transmission with an OCC or EDT transmission with an OCC.

Aspect 14: The method of any of Aspects 11-13, wherein the preamble or a RACH occasion (RO) is from a resource pool associated with OCC support for UEs.

Aspect 15: The method of any of Aspects 11-14, further comprising receiving an OCC indication that indicates how to monitor a downlink in association with OCC support.

Aspect 16: The method of any of Aspects 11-15, wherein the OCC configuration enables the UE to transmit uplink data during transmission of an RA-SDT using an OCC.

Aspect 17: The method of Aspect 16, wherein the OCC configuration is based at least in part on the preamble, and wherein the transmission is based at least in part on the OCC configuration.

Aspect 18: The method of Aspect 16, wherein receiving the OCC configuration includes receiving the OCC configuration in a random access response (RAR) or a msgB, and wherein the transmission is based at least in part on the OCC configuration.

Aspect 19: The method of Aspect 18, wherein the RAR or the msgB is for an OCC UE and is different than an RAR or a msgB for a non-OCC UE.

Aspect 20: The method of any of Aspects 11-15, wherein the OCC configuration enables the UE to transmit uplink data during transmission of an EDT using an OCC.

Aspect 21: The method of Aspect 20, wherein the OCC configuration is based at least in part on the preamble, and wherein the transmission is based at least in part on the OCC configuration.

Aspect 22: The method of Aspect 21, wherein receiving the OCC configuration includes receiving the OCC configuration in a random access response (RAR), and wherein the transmission is based at least in part on the OCC configuration.

Aspect 23: The method of Aspect 22, wherein the RAR is for an OCC UE and is different than an RAR for a non-OCC UE.

Aspect 24: The method of any of Aspects 11-23, further comprising receiving an updated OCC configuration that: changes one or more of the multiplexing order, the OCC codeword for the multiplexing order, and the OCC indication, disables use of an OCC for an RA-SDT or an EDT, or enables one or more of a new multiplexing order, a new OCC codeword for the new multiplexing order, or a new OCC indication for a next RA-SDT or a next EDT.

Aspect 25: A method of wireless communication performed by a network entity, comprising: receiving a preamble or a capability indication associated with orthogonal cover code (OCC) support for a configured grant (CG) small data transmission (SDT), a preconfigured uplink resource (PUR), a random access (RA) small data transmission (SDT) with a 4-step random access channel (RACH) procedure, an RA-SDT with a 2-step RACH procedure, or an early data transmission (EDT); and transmit, based at least in part on the capability indication, an OCC configuration that indicates a multiplexing order and an OCC codeword for the multiplexing order.

Aspect 26: The method of Aspect 25, further comprising transmitting an OCC indication that indicates whether to monitor a downlink in association with OCC support.

Aspect 27: The method of any of Aspects 25-26, wherein resources for OCC support for a CG-SDT, a PUR, an RA-SDT, or an EDT are different than resources for non-OCC support for a CG-SDT, a PUR, an RA-SDT, or an EDT.

Aspect 28: The method of any of Aspects 25-27, further comprising transmitting an indication to fall back to a transmission of the CG-SDT or the PUR without an OCC based at least in part on a determination that a transmission of the CG-SDT or the PUR with an OCC has failed.

Aspect 29: The method of any of Aspects 25-27, further comprising transmitting an indication to fall back to a transmission of the RA-SDT or the EDT without an OCC based at least in part on a determination that a transmission of the RA-SDT or the EDT with an OCC has failed.

Aspect 30: The method of any of Aspects 25-29, further comprising transmitting an updated OCC configuration that: changes one or more of the multiplexing order, the OCC codeword for the multiplexing order, and the OCC indication, disables use of an OCC for a CG-SDT, a PUR, an RA-SDT, or an EDT, or enables one or more of a new multiplexing order, a new OCC codeword for the new multiplexing order, or a new OCC indication for a next CG-SDT, a next PUR, a next RA-SDT, or a next EDT.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors coupled to the one or more memories, the one or more processors individually or collectively configured to cause the UE to:
transmit an indication of a capability for supporting an orthogonal cover code (OCC) for a configured grant (CG) small data transmission (SDT) or a preconfigured uplink resource (PUR); and
receive an OCC configuration that indicates a multiplexing order and an OCC codeword for the multiplexing order, and an OCC indication that indicates how to monitor a downlink in association with supporting the OCC for the CG-SDT or the PUR.

2. The apparatus of claim 1, wherein the one or more processors are individually or collectively configured to cause the UE to monitor for downlink communications based at least in part on the OCC indication.

3. The apparatus of claim 1, wherein to receive the OCC configuration, the one or more processors are individually or collectively configured to cause the UE to receive the OCC configuration in one or more radio resource control messages for CG-SDT and PUR.

4. The apparatus of claim 1, wherein the OCC configuration enables the UE to transmit uplink data during transmission of the CG-SDT using an OCC.

5. The apparatus of claim 1, wherein the OCC configuration enables the UE to transmit uplink data during transmission of the PUR using an OCC.

6. The apparatus of claim 1, wherein the one or more processors are individually or collectively configured to cause the UE to identify values in downlink control information (DCI) according to a first manner if OCC is supported and identify values in the DCI according to a second manner if OCC is not supported.

7. The apparatus of claim 1, wherein downlink control information (DCI) for an OCC-supported UE is different than DCI for a non-OCC-supported UE.

8. The apparatus of claim 1, wherein the one or more processors are individually or collectively configured to cause the UE to monitor a downlink (DL) in a first search space if OCC is supported and monitor the DL in a second search space if OCC is not supported.

9. The apparatus of claim 1, wherein the one or more processors are individually or collectively configured to cause the UE to transmit uplink data based at least in part on the OCC configuration.

10. The apparatus of claim 1, wherein the one or more processors are individually or collectively configured to cause the UE to receive an updated OCC configuration that:
changes one or more of the multiplexing order, the OCC codeword for the multiplexing order, or the OCC indication,
disables use of an OCC for a CG-SDT or a PUR, or
enables one or more of a new multiplexing order, a new OCC codeword for the new multiplexing order, or a new OCC indication for a next CG-SDT or a next PUR.

11. An apparatus for wireless communication at a user equipment (UE), comprising:
one or more memories; and
one or more processors coupled to the one or more memories, the one or more processors individually or collectively configured to cause the UE to:
transmit a preamble associated with orthogonal cover code (OCC) support for transmission of a random access (RA) small data transmission (SDT) with a 4-step random access channel (RACH) procedure, an RA-SDT with a 2-step RACH procedure, or an early data transmission (EDT); and
receive an OCC configuration that indicates a multiplexing order and an OCC codeword for the multiplexing order.

12. The apparatus of claim 11, wherein the one or more processors are individually or collectively configured to cause the UE to monitor for downlink communications based at least in part on the preamble that was transmitted.

13. The apparatus of claim 11, wherein the one or more processors are individually or collectively configured to cause the UE to receive a system information block (SIB) that enables SDT transmission with an OCC or EDT transmission with an OCC.

14. The apparatus of claim 11, wherein the preamble or a RACH occasion (RO) is from a resource pool associated with OCC support for UEs.

15. The apparatus of claim 11, wherein the one or more processors are individually or collectively configured to cause the UE to receive an OCC indication that indicates how to monitor a downlink in association with OCC support.

16. The apparatus of claim 11, wherein the OCC configuration enables the UE to transmit uplink data during transmission of an RA-SDT using an OCC.

17. The apparatus of claim 16, wherein the OCC configuration is based at least in part on the preamble, and wherein the transmission is based at least in part on the OCC configuration.

18. The apparatus of claim 16, wherein to receive the OCC configuration, the one or more processors are individually or collectively configured to cause the UE to receive the OCC configuration in a random access response (RAR) or a msgB, and wherein the transmission is based at least in part on the OCC configuration.

19. The apparatus of claim 18, wherein the RAR or the msgB is for an OCC UE and is different than an RAR or a msgB for a non-OCC UE.

20. The apparatus of claim 11, wherein the OCC configuration enables the UE to transmit uplink data during transmission of an EDT using an OCC.

21. The apparatus of claim 20, wherein the OCC configuration is based at least in part on the preamble, and wherein the transmission is based at least in part on the OCC configuration.

22. The apparatus of claim 21, wherein to receive the OCC configuration, the one or more processors are individually or collectively configured to cause the UE to receive the OCC configuration in a random access response (RAR), and wherein the transmission is based at least in part on the OCC configuration.

23. The apparatus of claim 22, wherein the RAR is for an OCC UE and is different than an RAR for a non-OCC UE.

24. The apparatus of claim 11, wherein the one or more processors are individually or collectively configured to cause the UE to receive an updated OCC configuration that:
changes one or more of the multiplexing order, the OCC codeword for the multiplexing order, and the OCC indication,
disables use of an OCC for an RA-SDT or an EDT, or
enables one or more of a new multiplexing order, a new OCC codeword for the new multiplexing order, or a new OCC indication for a next RA-SDT or a next EDT.

25. An apparatus for wireless communication at a network entity, comprising:
one or more memories; and
one or more processors coupled to the one or more memories, the one or more processors individually or collectively configured to cause the network entity to:
receive a preamble or a capability indication associated with orthogonal cover code (OCC) support for a configured grant (CG) small data transmission (SDT), a preconfigured uplink resource (PUR), a random access (RA) small data transmission (SDT) with a 4-step random access channel (RACH) procedure, an RA-SDT with a 2-step RACH procedure, or an early data transmission (EDT); and
transmit, based at least in part on the capability indication, an OCC configuration that indicates a multiplexing order and an OCC codeword for the multiplexing order.

26. The apparatus of claim 25, wherein the one or more processors are individually or collectively configured to cause the network entity to transmit an OCC indication that indicates whether to monitor a downlink in association with OCC support.

27. The apparatus of claim 25, wherein resources for OCC support for a CG-SDT, a PUR, an RA-SDT, or an EDT are different than resources for non-OCC support for a CG-SDT, a PUR, an RA-SDT, or an EDT.

28. The apparatus of claim 25, wherein the one or more processors are individually or collectively configured to cause the network entity to transmit an indication to fall back to a transmission of the CG-SDT or the PUR without an OCC based at least in part on a determination that a transmission of the CG-SDT or the PUR with an OCC has failed.

29. The apparatus of claim 25, wherein the one or more processors are individually or collectively configured to cause the network entity to transmit an indication to fall back to a transmission of the RA-SDT or the EDT without an OCC based at least in part on a determination that a transmission of the RA-SDT or the EDT with an OCC has failed.

30. The apparatus of claim 25, wherein the one or more processors are individually or collectively configured to cause the network entity to transmit an updated OCC configuration that:
changes one or more of the multiplexing order, the OCC codeword for the multiplexing order, and the OCC indication,
disables use of an OCC for a CG-SDT, a PUR, an RA-SDT, or an EDT, or
enables one or more of a new multiplexing order, a new OCC codeword for the new multiplexing order, or a new OCC indication for a next CG-SDT, a next PUR, a next RA-SDT, or a next EDT.
